(19) United States
(12) Patent Application Publication
(10) Pub. No.: US 2015/0163837 A1
(43) Pub. Date: Jun. 11, 2015

(54) METHOD, APPARATUS, AND SYSTEM FOR ESTABLISHING RADIO BEARER

(71) Applicant: Huawei Technologies Co., Ltd., Shenzhen (CN)

(72) Inventors: Yue Li, Shenzhen (CN); Xiaolong Guo, Beijing (CN)

(21) Appl. No.: 14/623,374

(22) Filed: Feb. 16, 2015

Related U.S. Application Data
(63) Continuation of application No. PCT/CN2012/080327, filed on Aug. 17, 2012.

(51) Int. Cl. H04W 76/02

(52) U.S. Cl. CPC H04W 76/02

(57) ABSTRACT

A method, an apparatus, and a system for establishing a radio bearer are provided. The method includes: determining, by a base station, an RB of a beneficial UE performing cooperative communication and a support UE corresponding to the RB of the beneficial UE; and sending cooperative RB configuration information of the beneficial UE to the beneficial UE, and sending cooperative RB configuration information of the support UE to the support UE, so that the beneficial UE and the support UE establish a corresponding cooperative RB, respectively, and the base station performs cooperative communication with the beneficial UE and the support UE.

### CROSS-REFERENCE TO RELATED APPLICATIONS

This application is a continuation of International Application No. PCT/CN2012/080327, filed on Aug. 17, 2012, which is hereby incorporated by reference in its entirety.

### TECHNICAL FIELD

The present invention relates to the field of communications, and in particular, to a method, an apparatus, and a system for establishing a radio bearer (RB).

### BACKGROUND

A UE (user equipment) may upload and download various kinds of data by applying a data communication service provided by a mobile communications system. Generally, in the prior art, the reliability of data transmission of a UE at a cell edge is improved by adopting CoMP (coordinated multi-point transmission/reception technology) and the throughput of the UE is improved by adopting CA (carrier aggregation). In the foregoing method, a data communication means is operated for a single UE, and once an environment where the UE itself is located is deteriorated, the reliability and/or the throughput of data transmission of UE will decrease sharply. In order to solve the problem, the concept of multiple users cooperative communication is put forward.

During multiple users cooperative communication, a procedure of sending data to a destination UE by a base station may be: first sending the data to a UE with a best channel condition that is near the destination UE, and then, forwarding the data to the final destination UE through a short-distance communication technology between UEs. In this way, multiple UEs cooperative communication, even though an environment where the destination UE itself is located is deteriorated and a channel condition is poor, the destination UE may still reliably receive the data forwarded by the UE with a good channel condition without affecting the throughput and the reliability of the destination UE.

Generally, a destination UE is called a beneficial UE, and a UE for forwarding data is called a support UE. When the foregoing multiple users cooperative communication method is performed, the base station needs to distribute the data sent to the beneficial UE to the support UE, and then, the data is forwarded to the beneficial UE by applying a short-distance communication protocol. Therefore, in order to complete the foregoing multiple users cooperative communication method, the support UE and the beneficial UE need to establish a cooperative RB (radio bearer) with a corresponding mapping relationship, and besides a protocol layer in the prior art, a cooperative layer providing functions such as data distribution and combination, channel quality monitoring, and radio bearer mapping is further introduced to the cooperative RB. In the prior art, a conventional RB established by each UE cannot be used to implement the foregoing multiple users cooperative communication.

### SUMMARY

Embodiments of the present invention provide a method, an apparatus, and a system for establishing a radio bearer, which can implement multiple users cooperative communication.

In order to achieve the objective, the embodiments of the present invention adopt the following technical solutions:

In a first aspect, the present invention provides a method for establishing an RB, including:

determining, by a base station, an RB of a beneficial UE performing cooperative communication and a support UE corresponding to the RB of the beneficial UE;

sending, by the base station, cooperative RB configuration information of the beneficial UE to the beneficial UE, and sending cooperative RB configuration information of the support UE to the support UE, so that the beneficial UE and the support UE establish a corresponding cooperative RB, respectively; and

performing, by the base station, cooperative communication with the beneficial UE and the support UE.

In a first possible implementation manner, the determining, by a base station, an RB of a beneficial UE performing cooperative communication and a support UE corresponding to the RB of the beneficial UE is specifically implemented as follows:

receiving, by the base station, an RRC message that carries a pairing identifier of the beneficial UE and an NAS message packet for requesting establishment of a bearer and is sent by the beneficial UE;

returning, by the base station, RB configuration information of the beneficial UE to the beneficial UE according to the received RRC message sent by the beneficial UE, so that the beneficial UE establishes a corresponding RB;

after receiving a radio resource control RRC message or a medium access control control element MAC CE that carries a pairing identifier of at least one UE and is sent by the at least one UE, reserving, by the base station, an RRC connection of the at least one UE, and storing the pairing identifier of the at least one UE; and

determining, by the base station, a UE with a pairing identifier that is consistent with the pairing identifier of the beneficial UE as the support UE corresponding to the RB of the beneficial UE.

In a second possible implementation manner, the determining, by a base station, an RB of a beneficial UE performing cooperative communication and a support UE corresponding to the RB of the beneficial UE is specifically implemented as follows:

receiving, by the base station, cooperative communication UE information sent by a core network device, where the cooperative communication UE information includes information of the beneficial UE that needs to perform cooperative communication;

determining, by the base station, according to the cooperative communication UE information, the beneficial UE performing cooperative communication, and sending RB configuration information of the beneficial UE to the beneficial UE, so that the beneficial UE establishes a corresponding RB; and

determining, by the base station, according to location information of the UE, a type of the UE, or channel information of the UE, the support UE corresponding to the RB of the beneficial UE.

In a third possible implementation manner, with reference to the first possible or the second possible implementation manner of the first aspect, the sending, by the base station, cooperative RB configuration information of the beneficial UE to the beneficial UE, and sending cooperative RB configuration information of the support UE to the support UE is specifically implemented as follows:

after determining the support UE corresponding to the RB of the beneficial UE performing cooperative communication, sending, by the base station, the cooperative RB configuration information of the beneficial UE to the beneficial UE, and sending the cooperative RB configuration information of the support UE to the support UE, respectively; or

when the RB configuration information of the beneficial UE that is sent by the base station to the beneficial UE is the cooperative RB configuration information, and the beneficial UE establishes the corresponding cooperative RB, after determining the support UE corresponding to the RB of the beneficial UE performing cooperative communication, sending, by the base station, the cooperative RB configuration information of the support UE to the corresponding support UE, so that the support UE establishes the corresponding cooperative RB.

In a fourth possible implementation manner, the determining, by a base station, an RB of a beneficial UE performing cooperative communication and a support UE corresponding to the RB of the beneficial UE includes:

receiving, by the base station, an RRC message or a MAC CE that carries a pairing identifier and is sent by the beneficial UE and other UEs, and using a UE with a pairing identifier that is consistent with a pairing identifier of the beneficial UE in the other UEs as the support UE corresponding to the RB of the beneficial UE; and

the sending, by the base station, cooperative RB configuration information of the beneficial UE to the beneficial UE, and sending cooperative RB configuration information of the support UE to the support UE includes:

sending, by the base station, the cooperative RB configuration information of the beneficial UE to the beneficial UE according to the received RRC message or MAC CE, and after knowing that the beneficial UE establishes the corresponding cooperative RB, determining the support UE corresponding to the RB of the beneficial UE; and sending, by the base station, the cooperative RB configuration information of the support UE to the corresponding support UE, so that the corresponding support UE establishes the corresponding cooperative RB; or

sending, by the base station, the cooperative RB configuration information of the beneficial UE to the beneficial UE, and sending the cooperative RB configuration information of the support UE to the support UE, respectively, so that the beneficial UE and the corresponding support UE establish the corresponding cooperative RB.

In a fifth possible implementation manner, the RRC message or the MAC CE that is sent by the beneficial UE and received by the base station further carries index information of an RB performing cooperative communication; and

the determining, by a base station, an RB of a beneficial UE performing cooperative communication and a support UE corresponding to the RB of the beneficial UE includes:

determining, by the base station, according to the index information of the RB, the RB of the beneficial UE performing cooperative communication, and using a UE with a pairing identifier that is consistent with the pairing identifier of the beneficial UE as the support UE corresponding to the RB of the beneficial UE performing cooperative communication.

In a sixth possible implementation manner, the determining, by a base station, an RB of a beneficial UE performing cooperative communication and a support UE corresponding to the RB of the beneficial UE includes:

receiving, by the base station, an RRC message or a MAC CE that carries a user identifier of the beneficial UE and is sent by the support UE; and

reserving, by the base station, an RRC connection of the support UE according to the RRC message or the MAC CE, and determining, according to the user identifier of the beneficial UE, that the support UE is the support UE corresponding to the RB of the beneficial UE, where the user identifier of the beneficial UE includes a cell radio network temporary identifier C-RNTI or a subscriber number of the beneficial UE.

In a seventh possible implementation manner, the determining, by a base station, an RB of a beneficial UE performing cooperative communication and a support UE corresponding to the RB of the beneficial UE includes:

determining, by the base station, the RB of the beneficial UE performing cooperative communication and the corresponding support UE according to location information of the UE, a type of the UE, or channel information of the UE.

In an eighth possible implementation manner, the determining, by the base station, according to location information of the UE, a type of the UE, or channel information of the UE, the RB of the beneficial UE performing cooperative communication and the support UE corresponding to the RB of the beneficial UE includes:

receiving, by the base station, an RRC message or a MAC CE that carries a cooperative communication request and is sent by the beneficial UE; and

determining, by the base station, according to the received RRC message or MAC CE that is sent by the beneficial UE, the RB of the beneficial UE performing cooperative communication; and determining the RB of the beneficial UE performing cooperative communication and the corresponding support UE according to the location information of the UE, the type of the UE, or the channel information of the UE.

The sending, by the base station, cooperative RB configuration information of the beneficial UE to the beneficial UE, and sending cooperative RB configuration information of the support UE to the support UE, respectively, includes:

sending, by the base station, the cooperative RB configuration information of the beneficial UE to the beneficial UE, and after knowing that the beneficial UE establishes the corresponding cooperative RB, determining the support UE corresponding to the RB of the beneficial UE performing cooperative communication; and sending, by the base station, the cooperative RB configuration information of the support UE to the support UE, so that the support UE establishes the corresponding cooperative RB; or

after determining the RB of the beneficial UE performing cooperative communication and the corresponding support UE, sending, by the base station, the cooperative RB configuration information of the support UE to the beneficial UE and the corresponding support UE, respectively, so that the beneficial UE and the support UE establish the corresponding cooperative RB, respectively.

In a second aspect, the present invention further provides a method for establishing an RB, which includes:

receiving, by a beneficial UE and a support UE in paired UEs, cooperative RB configuration information respectively corresponding to the beneficial UE and the support UE and sent by a base station, where the cooperative RB configuration information is sent by the base station after the base station determines an RB of the beneficial UE and the support UE in the paired UEs performing cooperative communication;

establishing, by the beneficial UE and the support UE in the paired UEs, a corresponding cooperative RB respectively according to the respective corresponding cooperative RB configuration information; and

performing, by the beneficial UE and the support UE in the paired UEs, cooperative communication with the base station, where

the paired UEs include one beneficial UE and at least one support UE.

In a first possible implementation manner, before the receiving, by a beneficial UE and a support UE in paired UEs, cooperative RB configuration information respectively corresponding to the beneficial UE and the support UE and sent by a base station, the method further includes:

obtaining, by the beneficial UE and the support UE in the paired UEs, a pairing identifier of the beneficial UE and a pairing identifier of the support UE, respectively;

sending, by the beneficial UE in the paired UEs, a radio resource control RRC message carrying the pairing identifier of the beneficial UE and an NAS message packet for requesting establishment of a bearer to the base station, so that the base station returns RB configuration information of the beneficial UE to the beneficial UE according to the received RRC message sent by the beneficial UE;

receiving, by the beneficial UE in the paired UEs, the RB configuration information of the beneficial UE that is returned by the base station, and establishing a corresponding RB according to the RB configuration information of the beneficial UE; and

sending, by the support UE in the paired UEs, an RRC message or a medium access control layer control element MAC CE that carries the pairing identifier of the support UE to the base station, so that the base station reserves an RRC connection of the support UE, stores the pairing identifier of the support UE, and determines the support UE consistent with the pairing identifier of the beneficial UE as a support UE corresponding to the RB of the beneficial UE.

In a second possible implementation manner, before the receiving, by a beneficial UE and a support UE in paired UEs, cooperative RB configuration information respectively corresponding to the beneficial UE and the support UE and sent by a base station, the method further includes:

receiving, by the beneficial UE in the paired UEs, RB configuration information of the beneficial UE that is sent by the base station, and establishing a corresponding RB according to the RB configuration information of the beneficial UE, so that the base station determines, according to location information of the UE, a type of the UE, or channel information of the UE, a support UE corresponding to the RB of the beneficial UE, where the RB configuration information of the beneficial UE is sent by the base station after determining, according to received cooperative communication UE information sent by a core network device, the beneficial UE performing cooperative communication, where the cooperative communication UE information includes information of the beneficial UE that needs to perform cooperative communication.

In a third possible implementation manner, before the receiving, by a beneficial UE and a support UE in paired UEs, cooperative RB configuration information respectively corresponding to the beneficial UE and the support UE and sent by a base station, the method further includes:

sending, by the beneficial UE and the support UE in the paired UEs, an RRC message or a MAC CE that carries a pairing identifier to the base station, respectively, so that the base station uses a UE with a pairing identifier that is consistent with the pairing identifier of the beneficial UE as a support UE corresponding to the RB of the beneficial UE.

In a fourth possible implementation manner, the RRC message or the MAC CE that is sent by the beneficial UE and the support UE in the paired UEs to the base station respectively further carries index information of an RB performing cooperative communication, so that the base station determines, according to the index information of the RB, the RB of the beneficial UE performing cooperative communication, and further, the base station uses a UE with a pairing identifier that is consistent with the pairing identifier of the beneficial UE as the support UE corresponding to the RB of the beneficial UE performing cooperative communication.

In a fifth possible implementation manner, before the receiving, by a beneficial UE and a support UE in paired UEs, cooperative RB configuration information respectively corresponding to the beneficial UE and the support UE and sent by a base station, the method further includes:

sending, by the support UE in the paired UEs, an RRC message or a MAC CE that carries a user identifier of the beneficial UE to the base station, so that the base station reserves an RRC connection of the support UE according to the RRC message or the MAC CE, and determines, according to the user identifier of the beneficial UE, that the support UE is a support UE corresponding to the RB of the beneficial UE, where the user identifier of the beneficial UE includes a cell radio network temporary identifier C-RNTI or a subscriber number of the beneficial UE.

In a sixth possible implementation manner, before the receiving, by a beneficial UE and a support UE in paired UEs, cooperative RB configuration information respectively corresponding to the beneficial UE and the support UE and sent by a base station, the method further includes:

sending, by the beneficial UE in the paired UEs, an RRC message or a MAC CE that carries a cooperative communication request to the base station, so that the base station determines, according to the received RRC message or MAC CE that is sent by the beneficial UE, the RB of the beneficial UE performing cooperative communication, and determines the RB of the beneficial UE performing cooperative communication and a corresponding support UE according to location information of the UE, a type of the UE, or channel information of the UE.

In a third aspect, the present invention further provides a base station, which includes:

a determining unit, configured to determine an RB of a beneficial UE performing cooperative communication and a support UE corresponding to the RB of the beneficial UE;

a configuration unit, configured to configure cooperative RB configuration information of the beneficial UE and cooperative RB configuration information of the support UE respectively for the beneficial UE and the support UE that are determined by the determining unit; and

a transceiver unit, configured to send the cooperative RB configuration information of the beneficial UE that is configured by the configuration unit to the beneficial UE, and send the cooperative RB configuration information of the support UE that is configured by the configuration unit to the support UE, so that the beneficial UE and the support UE establish a corresponding cooperative RB, respectively, where

the transceiver unit is further configured to transmit service data of the beneficial UE with the beneficial UE and the support UE to perform cooperative communication.

In a first possible implementation manner, the transceiver unit is further configured to receive an RRC message that carries a pairing identifier of the beneficial UE and an NAS message packet for requesting establishment of a bearer and is sent by the beneficial UE;

the configuration unit is further configured to send RB configuration information of the beneficial UE to the beneficial UE according to the RRC message sent by the beneficial UE and received by the transceiver unit;

the transceiver unit is further configured to send the RB configuration information of the beneficial UE that is configured by the configuration unit to the beneficial UE, so that the beneficial UE establishes the corresponding cooperative RB;

the transceiver unit is further configured to receive a radio resource control RRC message or a medium access control layer control element MAC CE that carries a pairing identifier of at least one UE and is sent by the at least one UE;

a processing unit is configured to reserve an RRC connection of the at least one UE and store the pairing identifier of the at least one UE according to the RRC message or the MAC CE that is sent by the at least one UE and received by the transceiver unit; and the determining unit is configured to determine a UE corresponding to a pairing identifier, which is consistent with the pairing identifier of the beneficial UE in the pairing identifier of the at least one UE that is received by the transceiver unit, as the support UE corresponding to the RB of the beneficial UE.

In a second possible implementation manner, the transceiver unit is further configured to receive cooperative communication UE information sent by a core network device, where the cooperative communication UE information includes information of the beneficial UE that needs to perform cooperative communication;

the determining unit is further configured to determine, according to the cooperative communication UE information, the beneficial UE performing cooperative communication;

the configuration unit is further configured to configure RB configuration information of the beneficial UE for the beneficial UE determined by the determining unit;

the transceiver unit is further configured to send the RB configuration information of the beneficial UE that is configured by the configuration unit to the beneficial UE, so that the beneficial UE establishes a corresponding RB; and

the determining unit is further configured to determine, according to location information of the UE, a type of the UE, or channel information of the UE, the support UE corresponding to the RB of the beneficial UE.

In a third possible implementation manner, with reference to the first possible or second possible implementation manner of the third aspect, when the RB configuration information of the beneficial UE that is configured by the configuration unit for the beneficial UE determined by the determining unit is conventional RB configuration information of the beneficial UE, the configuration unit is further configured to: after the determining unit determines the support UE corresponding to the RB of the beneficial UE performing cooperative communication, configure the cooperative RB configuration information of the beneficial UE and the cooperative RB configuration information of the support UE respectively for the beneficial UE and the support UE that are determined by the determining unit; and

the transceiver unit is further configured to send the cooperative RB configuration information of the beneficial UE that is configured by the configuration unit to the beneficial UE, and send the cooperative RB configuration information of the support UE that is configured by the configuration unit to the support UE, so that the beneficial UE and the support UE establish the corresponding cooperative RB, respectively; or

when the RB configuration information of the beneficial UE that is configured by the configuration unit for the beneficial UE determined by the determining unit is the cooperative RB configuration information of the beneficial UE, the transceiver unit is further configured to send the cooperative RB configuration information of the beneficial UE that is configured by the configuration unit to the beneficial UE, so that the beneficial UE establishes the corresponding cooperative RB;

the configuration unit is further configured to configure the cooperative RB configuration information of the support UE for the support UE after the determining unit determines the support UE corresponding to the RB of the beneficial UE performing cooperative communication; and

the transceiver unit is further configured to send the cooperative RB configuration information of the support UE that is configured by the configuration unit to the corresponding support UE, so that the support UE establishes the corresponding cooperative RB.

In a fourth possible implementation manner, the transceiver unit is further configured to receive RRC messages or MAC CEs that carry pairing identifiers and that are sent by the beneficial UE and other UEs;

the determining unit is configured to determine, according to the pairing identifier received by the transceiver unit, a UE with a pairing identifier that is consistent with a pairing identifier of the beneficial UE in the other UEs as the support UE corresponding to the RB of the beneficial UE;

the configuration unit configures the cooperative RB configuration information of the beneficial UE for the beneficial UE according to the RRC message or the MAC CE that is received by the transceiver unit;

the transceiver unit is configured to send the cooperative RB configuration information of the beneficial UE that is configured by the configuration unit to the beneficial UE, so that the beneficial UE establishes the corresponding cooperative RB;

the configuration unit is further configured to configure the cooperative RB configuration information of the support UE for the support UE after the determining unit determines the support UE corresponding to the RB of the beneficial UE; and

the transceiver unit is configured to send the cooperative RB configuration information of the support UE that is configured by the configuration unit to the support UE, so that the support UE establishes the corresponding cooperative RB; or

the configuration unit is further configured to: after the determining unit determines the support UE corresponding to the RB of the beneficial UE performing cooperative communication, configure the cooperative RB configuration information of the beneficial UE and the cooperative RB configuration information of the support UE respectively for the beneficial UE and the support UE that are determined by the determining unit; and

the transceiver unit is further configured to send the cooperative RB configuration information of the beneficial UE that is configured by the configuration unit to the beneficial UE, and send the cooperative RB configuration information of the support UE that is configured by the configuration unit to the support UE, so that the beneficial UE and the support UE establish the corresponding cooperative RB, respectively.

In a fifth possible implementation manner, the RRC message or the MAC CE that is sent by the beneficial UE and received by the transceiver unit further carries index information of an RB performing cooperative communication; and

the determining unit is further configured to determine, according to the index information of the RB, the RB of the beneficial UE performing cooperative communication, and use a UE with a pairing identifier that is consistent with the pairing identifier of the beneficial UE as the support UE corresponding to the RB of the beneficial UE performing cooperative communication.

In a sixth possible implementation manner, the transceiver unit is further configured to receive an RRC message or a MAC CE that carries a user identifier of the beneficial UE and is sent by the support UE; and

the determining unit is configured to reserve an RRC connection of the support UE according to the RRC message or the MAC CE that is received by the transceiver unit, and determine, according to the user identifier of the beneficial UE, that the support UE is the support UE corresponding to the RB of the beneficial UE, where the user identifier of the beneficial UE includes a cell radio network temporary identifier C-RNTI or a subscriber number of the beneficial UE.

In a seventh possible implementation manner, the determining unit is further configured to determine the RB of the beneficial UE performing cooperative communication and the corresponding support UE according to location information of the UE, a type of the UE, or channel information of the UE.

In an eighth possible implementation manner, the transceiver unit is further configured to receive an RRC message or a MAC CE that carries a cooperative communication request and is sent by the beneficial UE;

the determining unit is further configured to determine, according to the RRC message or the MAC CE that is sent by the beneficial UE and received by the transceiver unit, the RB of the beneficial UE performing cooperative communication, and determine the RB of the beneficial UE performing cooperative communication and the corresponding support UE according to the location information of the UE, the type of the UE, or the channel information of the UE;

the configuration unit configures the cooperative RB configuration information of the beneficial UE for beneficial UE according to the RRC message or the MAC CE that is sent by the beneficial UE and received by the transceiver unit;

the transceiver unit is configured to send the cooperative RB configuration information of the beneficial UE that is configured by the configuration unit to the beneficial UE, so that the beneficial UE establishes the corresponding cooperative RB;

the configuration unit is further configured to configure the cooperative RB configuration information of the support UE for the support UE after the determining unit determines the support UE corresponding to the RB of the beneficial UE; and

the transceiver unit is configured to send the cooperative RB configuration information of the support UE that is configured by the configuration unit to the support UE, so that the support UE establishes the corresponding cooperative RB; or the configuration unit is further configured to: after the determining unit determines the support UE corresponding to the RB of the beneficial UE performing cooperative communication, configure the cooperative RB configuration information of the beneficial UE and the cooperative RB configuration information of the support UE respectively for the beneficial UE and the support UE that are determined by the determining unit; and

the transceiver unit is further configured to send the cooperative RB configuration information of the beneficial UE that is configured by the configuration unit to the beneficial UE, and send the cooperative RB configuration information of the support UE that is configured by the configuration unit to the support UE, so that the beneficial UE and the support UE establish the corresponding cooperative RB, respectively.

In a fourth aspect, the present invention further provides paired UEs, which include: one beneficial UE and at least one support UE, where the beneficial UE includes: a transceiver unit and a bearer establishment unit, and the support UE includes a transceiver unit and a bearer establishment unit, where

the transceiver unit of the beneficial UE is configured to receive cooperative RB configuration information of the beneficial UE that is sent by a base station; and the transceiver unit of the support UE is configured to receive cooperative RB configuration information of the support UE that is sent by the base station, where the cooperative RB configuration information is sent by the base station after the base station determines an RB of the beneficial UE and the support UE in the paired UEs performing cooperative communication;

the bearer establishment unit of the beneficial UE is configured to establish a corresponding cooperative RB according to the cooperative RB configuration information received by the transceiver unit of the beneficial UE; and the bearer establishment unit of the support UE is configured to establish a corresponding cooperative RB according to the cooperative RB configuration information received by the transceiver unit of the support UE; and

the transceiver unit of the beneficial UE and the transceiver unit of the support UE perform cooperative communication with the base station.

In a first possible implementation manner, the beneficial UE further includes an obtaining unit, and the support UE further includes an obtaining unit, where

the obtaining unit of the beneficial UE is configured to obtain a pairing identifier of the beneficial UE; and the obtaining unit of the support UE is configured to obtain a pairing identifier of the support UE; and

the transceiver unit of the beneficial UE is further configured to send a radio resource control RRC message carrying the pairing identifier of the beneficial UE that is obtained by the obtaining unit of the beneficial UE and an NAS message packet for requesting establishment of a bearer to the base station, so that the base station returns RB configuration information of the beneficial UE to the beneficial UE according to the received RRC message sent by the beneficial UE;

the transceiver unit of the beneficial UE is further configured to receive the RB configuration information of the beneficial UE that is returned by the base station;

the bearer establishment unit of the beneficial UE is further configured to establish a corresponding RB according to the RB configuration information of the beneficial UE that is received by the transceiver unit of the beneficial UE; and

the transceiver unit of the support UE is further configured to send an RRC message or a medium access control layer control element MAC CE that carries the pairing identifier of the support UE to the base station, so that the base station reserves an RRC connection of the support UE, stores the pairing identifier of the support UE, and determines the support UE consistent with the pairing identifier of the beneficial UE as a support UE corresponding to the RB of the beneficial UE.

In a second possible implementation manner, the transceiver unit of the beneficial UE is further configured to receive RB configuration information of the beneficial UE that is sent by the base station; and

the bearer establishment unit of the beneficial UE is further configured to establish a corresponding RB according to the RB configuration information of the beneficial UE that is received by the transceiver unit of the beneficial UE, so that the base station determines, according to location information of the UE, a type of the UE, or channel information of the UE, a support UE corresponding to the RB of the beneficial UE, where the RB configuration information of the beneficial UE is sent by the base station after determining, according to received cooperative communication UE information sent by a core network device, the beneficial UE performing cooperative communication, where the cooperative communication UE information includes information of the beneficial UE that needs to perform cooperative communication.

In a third possible implementation manner, an obtaining unit of the beneficial UE is configured to obtain a pairing identifier of the beneficial UE; and an obtaining unit of the support UE is configured to obtain a pairing identifier of the support UE; and the transceiver unit of the beneficial UE is further configured to send an RRC message or a MAC CE that carries the pairing identifier obtained by the obtaining unit of the beneficial UE to the base station; and the transceiver unit of the support UE is further configured to send an RRC message or a MAC CE that carries the pairing identifier obtained by the obtaining unit of the support UE to the base station, so that the base station uses a UE with a pairing identifier that is consistent with the pairing identifier of the beneficial UE as a support UE corresponding to the RB of the beneficial UE.

With reference to the fourth aspect and the third possible implementation manner of the fourth aspect, in a fourth possible implementation manner, the RRC message or the MAC CE that is sent by the transceiver unit of the beneficial UE and the transceiver unit of the support UE to the base station respectively further carries index information of an RB performing cooperative communication, so that the base station determines, according to the index information of the RB, the RB of the beneficial UE performing cooperative communication, and further, the base station uses a UE with a pairing identifier that is consistent with the pairing identifier of the beneficial UE as the support UE corresponding to the RB of the beneficial UE performing cooperative communication.

In a fifth possible implementation manner, the transceiver unit of the support UE is further configured to send an RRC message or a MAC CE that carries a user identifier of the beneficial UE to the base station, so that the base station reserves an RRC connection of the support UE according to the RRC message or the MAC CE, and determines, according to the user identifier of the beneficial UE, that the support UE is a support UE corresponding to the RB of the beneficial UE, where the user identifier of the beneficial UE includes a cell radio network temporary identifier C-RNTI or a subscriber number of the beneficial UE.

In a sixth possible implementation manner, the transceiver unit of the beneficial UE is further configured to send an RRC message or a MAC CE that carries a cooperative communication request to the base station, so that the base station determines, according to the received RRC message or MAC CE that is sent by the beneficial UE, the RB of the beneficial UE performing cooperative communication, and determines the RB of the beneficial UE performing cooperative communication and a corresponding support UE according to location information of the UE, a type of the UE, or channel information of the UE.

In a fifth aspect, the present invention further provides a system for establishing an RB, including: a base station and paired UEs, where the paired UEs include one beneficial UE and at least one support UE, and

the base station is the base station described in the foregoing, and the paired UEs are the paired UEs described in the foregoing.

### BRIEF DESCRIPTION OF THE DRAWINGS

To describe the technical solutions in the embodiments of the present invention more clearly, the following briefly introduces accompanying drawings required for describing the embodiments. Apparently, the accompanying drawings in the following description show merely some embodiments of the present invention, and a person of ordinary skill in the art may still derive other drawings according to these accompanying drawings without creative efforts.

FIG. 1 is a schematic flowchart of a method for establishing an RB according to an embodiment of the present invention;

FIG. 2 is a schematic flowchart of another method for establishing an RB according to an embodiment of the present invention;

FIG. 3 is a schematic flowchart of a method for establishing an RB according to another embodiment of the present invention;

FIG. 4 is a schematic flowchart of another method for establishing an RB according to another embodiment of the present invention;

FIG. 5 is a schematic flowchart of another method for establishing an RB according to another embodiment of the present invention;

FIG. 6 is a structural block diagram of a base station according to another embodiment of the present invention;

FIG. 7 is a structural block diagram of a beneficial UE according to another embodiment of the present invention;

FIG. 8 is a structural block diagram of a support UE according to another embodiment of the present invention;

FIG. 9 is a structural block diagram of another base station according to another embodiment of the present invention;

FIG. 10 is a structural block diagram of another beneficial UE according to another embodiment of the present invention;

FIG. 11 is a structural block diagram of another support UE according to another embodiment of the present invention; and

FIG. 12 is a schematic structural diagram of a system for establishing an RB according to another embodiment of the present invention.

### DETAILED DESCRIPTION

The following clearly describes the technical solutions in the embodiments of the present invention with reference to the accompanying drawings in the embodiments of the present invention. Apparently, the embodiments to be described are merely apart rather than all of the embodiments of the present invention. All other embodiments obtained by a person of ordinary skill in the art based on the embodiments of the present invention without creative efforts shall fall within the protection scope of the present invention.

Basically, smart phones can support a short-distance communication technology (such as WiFi or BlueTooth) and a cellular communications technology (such as LTE, 3G UMTS, CDMA, 2G GSM, or WiMAX) at the same time. Taking that a cellular technology is SAE/LTE and a short-distance communication technology is the WiFi as an example, in a scenario of a single network node and cooperative communication between multiple users, or in a scenario called multiple UEs cooperative communication (MUCC), when at least two UEs have the characteristic of supporting the WiFi and the LTE at the same time, in order to improve the reliability and the throughput, an MUCC relationship may be established between the at least two UEs, that is, one UE of the at least two UEs needs to send data or receive data, and another UE other than the one UE may support and assist the one UE to perform communication. In the present invention, the one UE is named beneficial UE, served UE, or assisted UE, and the other UE other than the one UE is named support UE, serving UE, or assisting UE. The foregoing naming of the UEs is only an example taken in the present invention, and the naming of the UEs in the present invention includes but is not limited to the foregoing naming example.

Taking a support UE and a beneficial UE as an example, the beneficial UE may be a final data sender of uplink data or a final receiver of downlink data (from a cellular perspective). For a certain RB, generally, only one beneficial UE exists. The support UE is a UE configured to assist the beneficial UE to perform data relay. For a certain RB of the beneficial UE, multiple support UEs may exist.

Taking a support UE and a beneficial UE as an example, the concepts of the beneficial UE and the support UE are seen from the perspective of an RB of the beneficial UE, for example, a UE1 and a UE2 form MUCC, and they can assist and communicate with each other; in this way, from the perspective of a certain RB of the UE1, the UE2 may support the RB of the UE1, so that the UE1 is a beneficial UE, and the UE2 is a support UE. At the same time, the UE1 may also support a certain RB of the UE2, and from the perspective of the RB of the UE2, the UE2 is a beneficial UE, and the UE1 is a support UE.

Taking a support UE and a beneficial UE as an example, when the foregoing UEs are in a same short-distance connection range, a network may send downlink data to the foregoing support UE and beneficial UE, respectively (an optimized method is that the network scheduler always selects a UE with a best radio link condition at that time to send the data), and when the network sends the downlink data to the support UE, the support UE receives the data and sends the data to the beneficial UE through short-distance communication (such as the WiFi). Certainly, the data may also directly arrive at the beneficial UE, and the beneficial UE performs data combination. Similarly, uplink data of the beneficial UE may also be sent to the network through the beneficial UE itself or another support UE, and then the network performs data combination to complete cooperative communication between the UEs.

The reliability and throughput of communication of the beneficial UE may be improved through the assisted transmission of the support UE.

In embodiments provided in the present invention, an entity performing cooperative communication may be any entity in an access network or a core network, for example, an eNB, an S-GW, or a PGW in LTE, and for another example, a Node B, an RNC, an SGSN, or a GGSN in UMTS. Here, abase station in LTE is taken as an example to describe the solutions.

### Embodiment 1

As shown in FIG. 1, an embodiment of the present invention provides a method for establishing an RB, which is applied to a base station side. The method includes the following steps:

101: A base station determines an RB of a beneficial UE performing cooperative communication and a support UE corresponding to the RB of the beneficial UE.

In a conventional process of normal communication of a network, if a UE needs to perform a service such as data uploading after accessing an access network, the UE sends a non-access stratum (NAS) message for requesting establishment of a bearer to a core network device through a base station, and after receiving the NAS message, the core network device instructs the base station to establish an RB for the UE, so as to perform a relevant service. When an environment where the UE is located are poor, a signal is not good, and a relevant service cannot be normally performed, the UE may perform multiple users cooperative communication as a beneficial UE, and a support UE with a good signal that is near the beneficial UE forwards relevant service information in the network for the beneficial UE, so as to perform the relevant service.

The base station may determine the RB of the beneficial UE performing cooperative communication and the corresponding support UE according to a message that carries a pairing identifier and is sent by the beneficial UE and the support UE, or the base station determines the RB of the beneficial UE performing cooperative communication and the corresponding support UE according to a message that carries a user identifier of the beneficial UE and is sent by the support UE, or the base station determines the RB of the beneficial UE performing cooperative communication and the corresponding support UE according to location information of the UE, a type of the UE, or channel information of the UE.

102: The base station sends cooperative RB configuration information of the beneficial UE to the beneficial UE, and sends cooperative RB configuration information of the support UE to the support UE, so that the beneficial UE and the support UE establish a corresponding cooperative RB, respectively.

The base station may send the corresponding cooperative RB configuration information to the beneficial UE after determining the beneficial UE performing cooperative communication, so that the beneficial UE establishes the corresponding cooperative RB, and then, send the corresponding cooperative RB configuration information to the corresponding support UE after determining the support UE corresponding to the RB of the beneficial UE, so that the corresponding support UE establishes the corresponding cooperative RB, so as to perform cooperative communication. Optionally, the base station may also send the cooperative RB configuration information of the beneficial UE and the cooperative RB configuration information of the support UE to the beneficial UE and the corresponding support UE, respectively, after determining the RB of the beneficial UE and the support UE thereof, so that the beneficial UE and the corresponding support UE establish the corresponding cooperative RB.

103: The base station performs cooperative communication with the beneficial UE and the support UE.

The beneficial UE and the corresponding support UE establish the corresponding cooperative RB, and then the beneficial UE and the support UE establish a cooperative communication group. In the cooperative communication group, a support UE with a good signal may receive, through a corresponding cooperative RB, a part or all of data sent by the base station to the beneficial UE, and then forward the data to the beneficial UE through a short-distance communication protocol between the UEs, and after receiving the forwarded data, the beneficial UE combines, through a cooperative layer in the corresponding cooperative RB, the data forwarded by the support UE and the data received by the beneficial UE itself together, which may improve the throughput and the reliability.

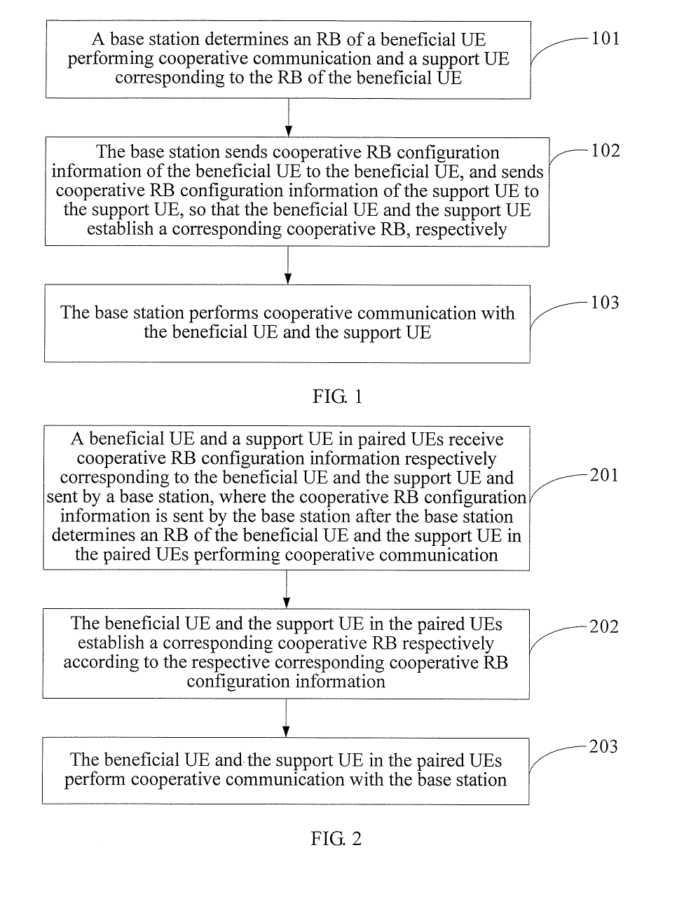

As shown in FIG. 2, an embodiment of the present invention provides a method for establishing an RB, which is applied to a paired UE side. The method includes the following steps:

201: A beneficial UE and a support UE in paired UEs receive cooperative RB configuration information respectively corresponding to the beneficial UE and the support UE and sent by a base station, where the cooperative RB configuration information is sent by the base station after the base station determines an RB of the beneficial UE and the support UE in the paired UEs performing cooperative communication.

The paired UEs include one beneficial UE and at least one support UE, and the beneficial UE and the support UE in the paired UEs are UEs performing cooperative communication that are determined by the base station. The base station sends the cooperative RB configuration information of the beneficial UE to the beneficial UE in the paired UEs and sends the cooperative RB configuration information of the support UE to the support UE after determining the RB of the beneficial UE and the support UE in the paired UEs performing cooperative communication. A sequence of sending the corresponding cooperative RB configuration information to the beneficial UE and the support UE by the base station is not limited. The beneficial UE and the support UE receive the cooperative RB configuration information respectively corresponding to the beneficial UE and the support UE and sent by the base station.

The base station may send the corresponding cooperative RB configuration information to the beneficial UE after determining the beneficial UE performing cooperative communication, so that the beneficial UE establishes a corresponding cooperative RB, and then, send the corresponding cooperative RB configuration information to the corresponding support UE after determining a support UE corresponding to the RB of the beneficial UE, so that the corresponding support UE establishes a corresponding cooperative RB, so as to perform cooperative communication. Optionally, the base station may also send the corresponding cooperative RB configuration information of the beneficial UE and the cooperative RB configuration information of the support UE to the beneficial UE and the corresponding support UE, respectively, after determining the RB of the beneficial UE and the support UE thereof.

202: The beneficial UE and the support UE in the paired UEs establish a corresponding cooperative RB respectively according to the respective corresponding cooperative RB configuration information.

The beneficial UE configures the cooperative RB of the beneficial UE according to the cooperative RB configuration information of the beneficial UE and establishes the cooperative RB of the beneficial UE; and the support UE configures the cooperative RB of the support UE according to the cooperative RB configuration information of the support UE, and establishes the cooperative RB of the support UE.

203: The beneficial UE and the support UE in the paired UEs perform cooperative communication with the base station.

The beneficial UE and the corresponding support UE establish the corresponding cooperative RB, and then the beneficial UE and the support UE establish a cooperative communication group. In the cooperative communication group, a support UE with a good signal may receive, through a corresponding cooperative RB, a part or all of data sent by the base station to the beneficial UE, and then forward the data to the beneficial UE through a short-distance communication protocol between the UEs, and after receiving the forwarded data, the beneficial UE combines, through a cooperative layer in the corresponding cooperative RB, the data forwarded by the support UE and the data received by the beneficial UE itself together, which may improve the throughput and the reliability.

Embodiments of the present invention provide a method, an apparatus, and a system for establishing a radio bearer. Abase station determines an RB of a beneficial UE performing cooperative communication and a corresponding support UE, and sends configured corresponding cooperative RB configuration information to the beneficial UE and the corresponding support UE, so that the beneficial UE and the corresponding support UE establish a corresponding cooperative RB; therefore, a cooperative communication group is formed, and cooperative communication may be performed.

### Embodiment 2

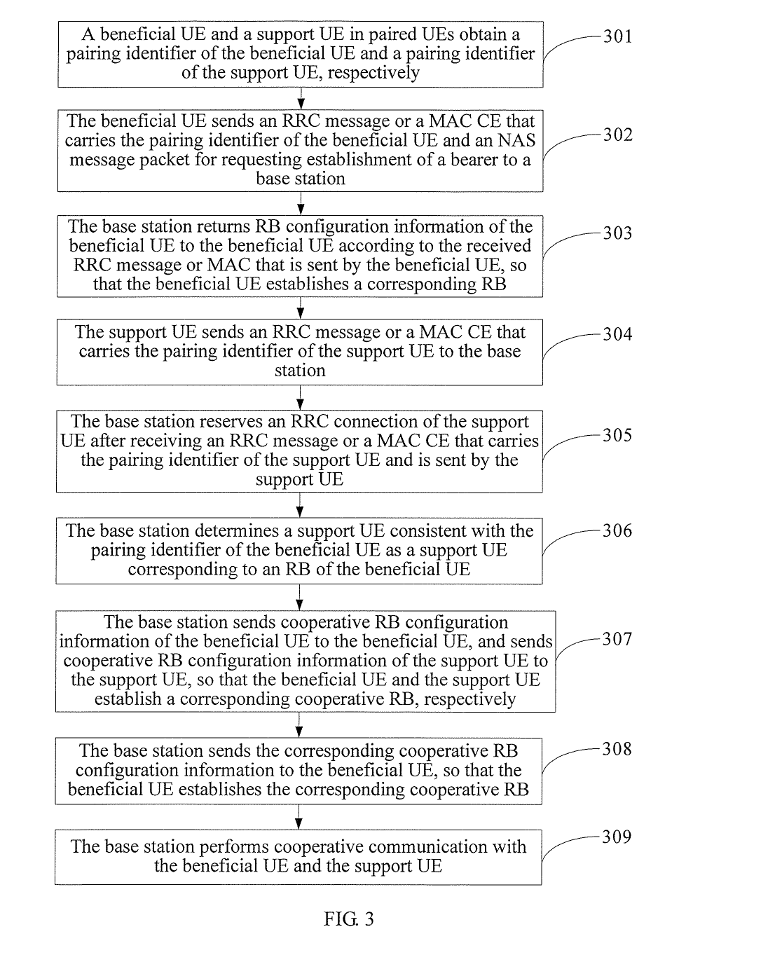

An embodiment of the present invention provides a method for establishing a radio bearer. Abase station may determine, according to a message that carries a pairing identifier and is sent by a beneficial UE and a support UE, an RB of the beneficial UE performing cooperative communication and a corresponding support UE. As shown in FIG. 3, the method includes the following steps:

301: A beneficial UE and a support UE in paired UEs obtain a pairing identifier of the beneficial UE and a pairing identifier of the support UE, respectively.

When the beneficial UE is close to the support UE, the beneficial UE may negotiate with the support UE to obtain the pairing identifier of the beneficial UE performing cooperative communication and the pairing identifier of the support UE, respectively. Alternatively, a user may perform negotiation and configure the pairing identifier of the beneficial UE performing cooperative communication and the pairing identifier of the support UE for the beneficial UE and the support UE. Here, the pairing identifier may include a random number, a subscriber number, a uniform group-RNTI, or the like of any one of the beneficial UE and the support UE.

302: The beneficial UE sends an RRC message or a MAC CE that carries the pairing identifier of the beneficial UE and an NAS message packet for requesting establishment of a bearer to a base station.

In the prior art, when the beneficial UE and the support UE do not establish a conventional RB with the base station and are not in an RRC connection state, and when the beneficial UE needs to perform a service and establish a bearer, the beneficial UE sends the NAS message for requesting establishment of a bearer to a core network device through the base station, and after receiving the NAS message, the core network device instructs the base station to establish a conventional RB for the beneficial UE. Here, in order to send the NAS message for requesting establishment of a bearer that is initiated by the beneficial UE to a core network, the beneficial UE needs to exchange several RRC messages with the base station, and finally packages and encapsulates the NAS message in an RRC message and sends the message to the base station, and then, the base station parses the RRC message to obtain the NAS message, and then transparently forwards the NAS message to the core network. The beneficial UE sends multiple RRC messages in this process, and may send the pairing identifier of the beneficial UE to the base station in any one of the RRC messages, which may specifically be an RRC connection request message or an RRC connection establishment completion message.

Optionally, when the beneficial UE and the support UE have established a conventional RB with base station and are in an RRC connection state, the beneficial UE may directly send the RRC message or the MAC CE that carries the pairing identifier of the beneficial UE to the base station.

303: The base station returns RB configuration information of the beneficial UE to the beneficial UE according to the received RRC message or MAC CE that is sent by the beneficial UE, so that the beneficial UE establishes a corresponding RB.

Optionally, when the beneficial UE and the support UE do not establish a conventional RB with the base station and are not in an RRC connection state, after parsing the RRC message to obtain the NAS message for requesting establishment of a bearer, the base station forwards the message to a core network device, and after receiving the NAS message, the core network device instructs the base station to establish a bearer for the beneficial UE. At this time, the base station may send corresponding conventional RB configuration information to the beneficial UE, so that the beneficial UE establishes a corresponding conventional RB; and the base station may also send corresponding cooperative RB configuration information to the beneficial UE, so that the beneficial UE establishes a corresponding cooperative RB, which is not limited herein.

When the beneficial UE and the support UE have established a conventional RB with the base station and are in an RRC connection state, the base station may return cooperative RB configuration information of the beneficial UE to the beneficial UE according to the received RRC message or MAC CE that is sent by the beneficial UE, or may not return cooperative RB configuration information of the beneficial UE.

304: The support UE sends an RRC message or a MAC CE (medium access control control element) that carries the pairing identifier of the support UE to the base station.

When the beneficial UE and the support UE do not establish a conventional RB with the base station and are not in an RRC connection state, the support UE itself has no service, and after the support UE negotiates the pairing identifier with the beneficial UE, a TAU (tracking area update) procedure is triggered by an application layer and an RRC connection is established. In the TAU procedure, the pairing identifier of the support UE is carried through the RRC message or the MAC CE and is sent to the base station. In conventional LTE, TAU is a location update message periodically sent by a UE to a core network, and the core network does not establish a bearer for the UE after receiving the message. Here, for the support UE in cooperative communication, a core network bearer does not need to be established; therefore, here, the negotiated pairing identifier of the support UE may be notified to the base station by using an existing TAU procedure. Certainly, another existing NAS procedure for establishing a bearer by the core network may replace the TAU procedure.

When the beneficial UE and the support UE have already established a conventional RB with the base station and are in an RRC connection state, the support UE may directly send an RRC message or a MAC CE that carries the pairing identifier of the support UE to the base station.

305: The base station reserves an RRC connection of the support UE after receiving an RRC message or a MAC CE that carries the pairing identifier of the support UE and is sent by the support UE.

When the beneficial UE and the support UE do not establish a conventional RB with the base station and are not in an RRC connection state, after the TAU procedure ends, in conventional LTE, the base station releases an RRC link; however, because, at this time, the support UE carries the pairing identifier in the previous RRC message to the base station, the base station knows that the UE establishes the RRC connection for cooperative communication, and therefore does not release the RRC link quickly but stores context of the UE, and uses the pairing identifier of the support UE to match a beneficial UE paired with the support UE.

When the beneficial UE and the support UE have established a conventional RB with the base station and are in an RRC connection state, the RRC connection is always reserved.

Here, it should be noted that, a sequence of steps 302 and 303, and steps 304 and 305 is not limited, and FIG. 3 only shows one situation: steps 302 and 303 are performed before steps 304 and 305; optionally, steps 302 and 303 may also be performed after steps 304 and 305.

306: The base station determines a support UE consistent with the pairing identifier of the beneficial UE as a support UE corresponding to an RB of the beneficial UE.

The base station may receive a bearer establishment request that carries a pairing identifier and is sent by the beneficial UE, and RRC messages or MAC CEs that carry the pairing identifier of the support UE and are sent by many support UEs. The base station uses the support UE consistent with the pairing identifier of the beneficial UE as the support UE corresponding to the RB of the beneficial UE; in this way, the base station determines the RB of the beneficial UE performing cooperative communication and the corresponding support UE.

307: The base station sends cooperative RB configuration information of the beneficial UE to the beneficial UE, and sends cooperative RB configuration information of the support UE to the support UE, so that the beneficial UE and the support UE establish a corresponding cooperative RB, respectively.

The base station sends the corresponding cooperative RB configuration information to the corresponding support UE after determining the RB of the beneficial UE performing cooperative communication and the corresponding support UE, so that the corresponding support UE establishes the corresponding cooperative RB, and the support UE receives, through the cooperative RB, a part of service data of the beneficial UE that is sent by the base station, so as to perform cooperative communication.

If the RB configuration information sent by the base station to the beneficial UE in step 303 is the corresponding cooperative RB configuration information, the beneficial UE has established the corresponding cooperative RB, and at this time, both the beneficial UE and the corresponding support UE establish the corresponding cooperative RB, and cooperative communication may be performed.

If the RB configuration information sent by the base station to the beneficial UE in step 303 is corresponding conventional RB configuration information, a conventional RB is established by the beneficial UE, and the conventional RB does not support cooperative communication, and at this time, step 308 needs to be performed.

308: The base station sends the corresponding cooperative RB configuration information to the beneficial UE, so that the beneficial UE establishes the corresponding cooperative RB.

The base station sends the corresponding cooperative RB configuration information to the beneficial UE, and the beneficial UE updates the conventional RB established by the beneficial UE to a cooperative RB after receiving the RB configuration information. So far, both the beneficial UE and the corresponding support UE establish the corresponding cooperative RB, and cooperative communication may be performed.

If step 308 exists, a sequence of step 308 and step 307 is not limited.

It should be noted that, when the beneficial UE and the support UE have established a conventional RB with the base station and are in an RRC connection state, the RRC message or the MAC CE that is sent by the beneficial UE to the base station in step 302 may further carry index information of an RB performing cooperative communication; in this way, the base station may also determine, according to the index information of the RB, the RB of the beneficial UE performing cooperative communication in step 306, and then, use a UE with a pairing identifier that is consistent with the pairing identifier of the beneficial UE as the support UE corresponding to the RB of the beneficial UE performing cooperative communication.

309: The base station performs cooperative communication with the beneficial UE and the support UE.

The beneficial UE and the corresponding support UE establish the corresponding cooperative RB, and then the beneficial UE and the support UE establish a cooperative communication group. In the cooperative communication group, a support UE with a good signal may receive, through a corresponding cooperative RB, a part or all of data sent by the base station to the beneficial UE, and then forward the data to the beneficial UE through a short-distance communication protocol between the UEs, and after receiving the forwarded data, the beneficial UE combines, through a cooperative layer in the corresponding cooperative RB, the data forwarded by the support UE and the data received by the beneficial UE itself together, which may improve the throughput and the reliability.

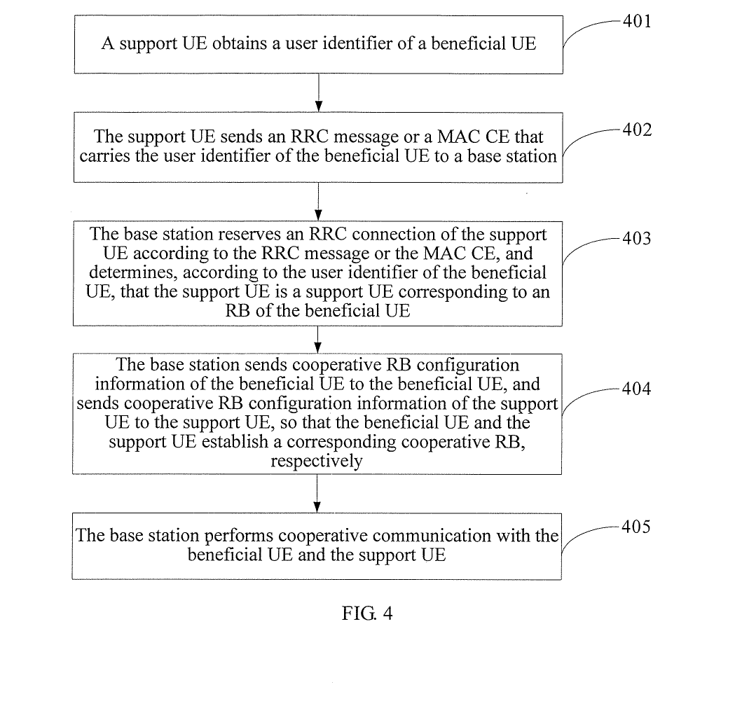

An embodiment of the present invention further provides a method for establishing a radio bearer. A base station may determine, according to a message that carries a user identifier of a beneficial UE and is sent by a support UE, an RB of the beneficial UE performing cooperative communication and a corresponding support UE. As shown in FIG. 4, the method includes the following steps:

401: A support UE obtains a user identifier of a beneficial UE.

402: The support UE sends an RRC message or a MAC CE that carries the user identifier of the beneficial UE to a base station.

403: The base station reserves an RRC connection of the support UE according to the RRC message or the MAC CE, and determines, according to the user identifier of the beneficial UE, that the support UE is a support UE corresponding to an RB of the beneficial UE.

The user identifier of the beneficial UE includes a cell radio network temporary identifier C-RNTI or a subscriber number of the beneficial UE.

404: The base station sends cooperative RB configuration information of the beneficial UE to the beneficial UE, and sends cooperative RB configuration information of the support UE to the support UE, so that the beneficial UE and the support UE establish a corresponding cooperative RB, respectively.

The sequence of sending the cooperative RB configuration information of the beneficial UE to the beneficial UE and sending the cooperative RB configuration information of the support UE to the corresponding support UE by the base station is not limited. The beneficial UE and the corresponding support UE establish the corresponding cooperative RB after receiving the respective cooperative RB configuration information.

405: The base station performs cooperative communication with the beneficial UE and the support UE.

The beneficial UE and the corresponding support UE establish the corresponding cooperative RB, and then the beneficial UE and the support UE establish a cooperative communication group. In the cooperative communication group, a support UE with a good signal may receive, through a corresponding cooperative RB, a part or all of data sent by the base station to the beneficial UE, and then forward the data to the beneficial UE through a short-distance communication protocol between the UEs, and after receiving the forwarded data, the beneficial UE combines, through a cooperative layer in the corresponding cooperative RB, the data forwarded by the support UE and the data received by the beneficial UE itself together, which may improve the throughput and the reliability.

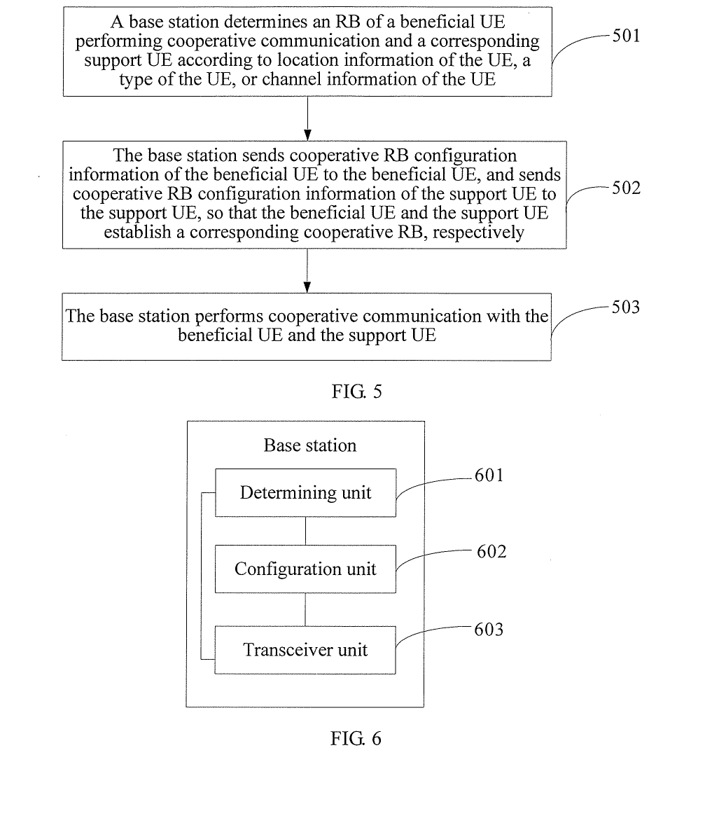

An embodiment of the present invention further provides a method for establishing a radio bearer. Abase station may determine an RB of a beneficial UE performing cooperative communication and a corresponding support UE according to location information of the UE, a type of the UE, or channel information of the UE. As shown in FIG. 5, the method includes the following steps:

501: A base station determines an RB of a beneficial UE performing cooperative communication and a corresponding support UE according to location information of the UE, a type of the UE, or channel information of the UE.

The base station may directly determine the RB of the beneficial UE performing cooperative communication and the corresponding support UE according to location information of all UEs served by the base station, a type of a UE, or channel information of the UE. For example, the base station may determine a UE of which a distance to the beneficial UE is smaller than a preset threshold as the support UE corresponding to the RB of the beneficial UE, or determine a UE with a good channel quality as the support UE corresponding to the RB of the beneficial UE; or a dedicated support UE is set in a cell covered by the base station, and the base station may determine the dedicated support UE as the support UE corresponding to the RB of the beneficial UE.

Optionally, before determining the RB of the beneficial UE performing cooperative communication and the corresponding support UE, the base station may further receive an RRC message or a MAC CE that is sent by the beneficial UE, and the base station determines, according to the received RRC message or MAC CE, the RB of the beneficial UE performing cooperative communication, and determines the RB of the beneficial UE performing cooperative communication and the corresponding support UE according to the location information of the UE, the type of the UE, or the channel information of the UE.

Optionally, before determining the RB of the beneficial UE performing cooperative communication and the corresponding support UE, the base station may further receive cooperative communication UE information sent by a core network device, where the cooperative communication UE information includes information of the beneficial UE that needs to perform cooperative communication; and the base station may determine, according to the cooperative communication UE information, the beneficial UE performing cooperative communication, and send RB configuration information of the beneficial UE to the beneficial UE, so that the beneficial UE establishes a corresponding RB, and then, the base station determines the RB of the beneficial UE and the corresponding support UE according to the location information of the UE, the type of the UE, or channel information of the UE.

502: The base station sends cooperative RB configuration information of the beneficial UE to the beneficial UE, and sends cooperative RB configuration information of the support UE to the support UE, so that the beneficial UE and the support UE establish a corresponding cooperative RB, respectively.

The sequence of sending the cooperative RB configuration information of the beneficial UE to the beneficial UE and sending the cooperative RB configuration information of the support UE to the corresponding support UE by the base station is not limited. The beneficial UE and the corresponding support UE establish the corresponding cooperative RB after receiving the respective cooperative RB configuration information.

Herein, it should be noted that, in step 502, when receiving the cooperative communication UE information and determining the beneficial UE performing cooperative communication, the base station sends the RB configuration information of the beneficial UE to the beneficial UE, here, the RB configuration information of the beneficial UE may be conventional RB configuration information or the cooperative RB configuration information. If the RB configuration information is conventional RB configuration information, the beneficial UE establishes a conventional RB, and the base station sends the cooperative RB configuration information of the beneficial UE to the beneficial UE, and sends the cooperative RB configuration information of the support UE to the support UE respectively after determining the support UE corresponding to the RB of the beneficial UE performing cooperative communication. If the RB configuration information of the beneficial UE that is sent by the base station to the beneficial UE is the cooperative RB configuration information, the beneficial UE establishes the corresponding cooperative RB, and the base station sends the cooperative RB configuration information of the support UE to the corresponding support UE after determining the support UE corresponding to the RB of the beneficial UE performing cooperative communication, so that the support UE establishes the corresponding cooperative RB.

503: The base station performs cooperative communication with the beneficial UE and the support UE.

The beneficial UE and the corresponding support UE establish the corresponding cooperative RB, and then the beneficial UE and the support UE establish a cooperative communication group. In the cooperative communication group, a support UE with a good signal may receive, through a corresponding cooperative RB, a part or all of data sent by the base station to the beneficial UE, and then forward the data to the beneficial UE through a short-distance communication protocol between the UEs, and after receiving the forwarded data, the beneficial UE combines, through a cooperative layer in the corresponding cooperative RB, the data forwarded by the support UE and the data received by the beneficial UE itself together, which may improve the throughput and the reliability.

In a process of establishing a cooperative RB by using the methods provided by all the foregoing embodiments, after receiving the cooperative RB configuration information sent by the base station, the support UE may reject to establish the cooperative RB due to absence of a supporting capability of the support UE, a user policy or a poor state of a short-distance link, or the like, and send a cooperative RB establishment rejection message to the base station. The base station may perform cooperative communication with the support UE and the beneficial UE that establish the cooperative RB.

An embodiment of the present invention further provides a base station. As shown in FIG. 6, the base station includes a determining unit 601, a configuration unit 602, and a transceiver unit 603.

The determining unit 601 is configured to determine an RB of a beneficial UE performing cooperative communication and a support UE corresponding to the RB of the beneficial UE.

In a conventional process of normal communication of a network, if a UE needs to perform a service such as data uploading after accessing an access network, the UE sends an NAS message for requesting establishment of a bearer to a core network device through a base station, and after receiving the NAS message, the core network device instructs the base station to establish an RB for the UE, so as to perform a relevant service. When an environment where the UE is located are poor, a signal is not good, and a relevant service cannot be normally performed, the UE may perform multiple users cooperative communication as a beneficial UE, and a support UE with a good signal that is near the beneficial UE forwards relevant service information in the network for the beneficial UE, so as to perform the relevant service.

The determining unit 601 of the base station may determine the RB of the beneficial UE performing cooperative communication and the corresponding support UE according to a message that carries a pairing identifier and is sent by the beneficial UE and the support UE, or the determining unit 601 of the base station determines the RB of the beneficial UE performing cooperative communication and the corresponding support UE according to a message that carries a user identifier of the beneficial UE and is sent by the support UE, or the determining unit 601 of the base station determines the RB of the beneficial UE performing cooperative communication and the corresponding support UE according to location information of the UE, a type of the UE, or channel information of the UE. For example, the determining unit 601 of the base station may determine a UE of which a distance to the beneficial UE is smaller than a preset threshold as the support UE corresponding to the RB of the beneficial UE, or determine a UE with a good channel quality as the support UE corresponding to the RB of the beneficial UE; or a dedicated support UE is set in a cell covered by the base station, and the determining unit 601 of the base station may determine the dedicated support UE as the support UE corresponding to the RB of the beneficial UE.

The configuration unit 602 is configured to configure cooperative RB configuration information of the beneficial UE and cooperative RB configuration information of the support UE respectively for the beneficial UE and the support UE that are determined by the determining unit 601.

The transceiver unit 603 is configured to send the cooperative RB configuration information of the beneficial UE that is configured by the configuration unit 602 to the beneficial UE, and send the cooperative RB configuration information of the support UE that is configured by the configuration unit 602 to the support UE, so that the beneficial UE and the support UE establish a corresponding cooperative RB, respectively.

The transceiver unit 603 is further configured to transmit service data of the beneficial UE with the beneficial UE and the support UE to perform cooperative communication.

The beneficial UE and the corresponding support UE establish the corresponding cooperative RB, and then the beneficial UE and the support UE establish a cooperative communication group. In the cooperative communication group, a support UE with a good signal may receive, through a corresponding cooperative RB, a part or all of data sent by the base station to the beneficial UE, and then forward the data to the beneficial UE through a short-distance communication protocol between the UEs, and after receiving the forwarded data, the beneficial UE combines, through a cooperative layer in the corresponding cooperative RB, the data forwarded by the support UE and the data received by the beneficial UE itself together, which may improve the throughput and the reliability.

In the embodiment provided in the present invention, the base station may determine the RB of the beneficial UE performing cooperative communication and the corresponding support UE according to the message that carries the pairing identifier and is sent by the beneficial UE and the support UE, or the base station determines the RB of the beneficial UE performing cooperative communication and the corresponding support UE according to the message that carries the user identifier of the beneficial UE and is sent by the support UE, or the base station determines the RB of the beneficial UE performing cooperative communication and the corresponding support UE according to the location information of the UE, the type of the UE, or the channel information of the UE.

In a situation in which the base station determines the RB of the beneficial UE performing cooperative communication and the corresponding support UE according to the message that carries the pairing identifier and is sent by the beneficial UE and the support UE:

When the beneficial UE and the support UE do not establish a conventional RB with the base station and are not in an RRC connection state, the transceiver unit 603 is further configured to receive an RRC message that carries a pairing identifier of the beneficial UE and an NAS message packet for requesting establishment of a bearer and is sent by the beneficial UE; the configuration unit 602 is further configured to send RB configuration information of the beneficial UE to the beneficial UE according to the RRC message sent by the beneficial UE and received by the transceiver unit 603; the transceiver unit 603 is further configured to send the RB configuration information of the beneficial UE that is configured by the configuration unit 602 to the beneficial UE, so that the beneficial UE establishes the corresponding cooperative RB; the transceiver unit 603 is further configured to receive a radio resource control RRC message or a medium access control layer control element MAC CE that carries a pairing identifier of at least one UE and is sent by the at least one UE; a processing unit is configured to reserve an RRC connection of the at least one UE and store the pairing identifier of the at least one UE according to the RRC message or the MAC CE that is sent by the at least one UE and received by the transceiver unit 603; and the determining unit 601 is configured to determine a UE corresponding to a pairing identifier, which is consistent with the pairing identifier of the beneficial UE in the pairing identifier of the at least one UE that is received by the transceiver unit, as the support UE corresponding to the RB of the beneficial UE.

When the beneficial UE and the support UE have established a conventional RB with the base station and are in RRC connection state, the transceiver unit 603 is further configured to receive RRC messages or MAC CEs that carry pairing identifiers and that are sent by the beneficial UE and other UEs; and the determining unit 601 is configured to determine, according to the pairing identifier received by the transceiver unit 603, a UE with a pairing identifier that is consistent with the pairing identifier of the beneficial UE in the other UEs as the support UE corresponding to the RB of the beneficial UE. Optionally, the RRC message or the MAC CE that is sent by the beneficial UE and received by the transceiver unit 603 further carries index information of an RB performing cooperative communication; and the determining unit 601 is further configured to determine, according to the index information of the RB, the RB of the beneficial UE performing cooperative communication, and use a UE with a pairing identifier that is consistent with the pairing identifier of the beneficial UE as the support UE corresponding to the RB of the beneficial UE performing cooperative communication.

When the RB configuration information of the beneficial UE that is configured by the base station for the beneficial UE according to the RRC message or the MAC CE that is received by the transceiver unit 603 is the cooperative RB configuration information, the configuration unit 602 is configured to configure the cooperative RB configuration information of the beneficial UE for the beneficial UE according to the RRC message or the MAC CE that is received by the transceiver unit 603; the transceiver unit 603 is configured to send the cooperative RB configuration information of the beneficial UE that is configured by the configuration unit 602 to the beneficial UE, so that the beneficial UE establishes the corresponding cooperative RB; the configuration unit 602 is further configured to configure the cooperative RB configuration information of the support UE of the support UE after the determining unit 601 determines the support UE corresponding to the RB of the beneficial UE; and the transceiver unit 603 is configured to send the cooperative RB configuration information of the support UE that is configured by the configuration unit 602 to the support UE, so that the support UE establishes the corresponding cooperative RB.

When the RB configuration information of the beneficial UE that is configured by the base station for the beneficial UE according to the RRC message or the MAC CE that is received by the transceiver unit 603 is conventional RB configuration information, the configuration unit 602 is further configured to: after the determining unit 601 determines the support UE corresponding to the RB of the beneficial UE performing cooperative communication, configure the cooperative RB configuration information of the beneficial UE and the cooperative RB configuration information of the support UE respectively for the beneficial UE and the support UE that are determined by the determining unit 601; and the transceiver unit 603 is further configured to send the cooperative RB configuration information of the beneficial UE that is configured by the configuration unit 602 to the beneficial UE and send the cooperative RB configuration information of the support UE that is configured by the configuration unit 602 to the support UE, so that the beneficial UE and the support UE establish the corresponding cooperative RB, respectively.

The pairing identifier includes a random number, a subscriber number of any one of the beneficial UE and the support UE or a uniform group radio network temporary identifier group-RNTI.

In a situation in which the base station determines the RB of the beneficial UE performing cooperative communication and the corresponding support UE according to the message that carries the user identifier of the beneficial UE and is sent by the support UE:

The transceiver unit 603 is further configured to receive an RRC message or a MAC CE that carries the user identifier of the beneficial UE and is sent by the support UE; and the determining unit 601 is configured to reserve an RRC connection of the support UE according to the RRC message or the MAC CE that is received by the transceiver unit 603, and determine, according to the user identifier of the beneficial UE, that the support UE is the support UE corresponding to the RB of the beneficial UE, where the user identifier of the beneficial UE includes a cell radio network temporary identifier C-RNTI or a subscriber number of the beneficial UE.

In a situation in which the base station determines the RB of the beneficial UE performing cooperative communication and the corresponding support UE according to the location information of the UE, the type of the UE, or the channel information of the UE:

The determining unit 601 is further configured to determine the RB of the beneficial UE performing cooperative communication and the corresponding support UE according to the location information of the UE, the type of the UE, or the channel information of the UE.

Optionally, the transceiver unit 603 is further configured to receive cooperative communication UE information sent by a core network device, where the cooperative communication UE information includes information of the beneficial UE that needs to perform cooperative communication; the determining unit 601 is further configured to determine, according to the cooperative communication UE information, the beneficial UE performing cooperative communication; the configuration unit 602 is further configured to configure the RB configuration information of the beneficial UE for the beneficial UE determined by the determining unit 601; the transceiver unit 603 is further configured to send the RB configuration information of the beneficial UE that is configured by the configuration unit 602 to the beneficial UE, so that the beneficial UE establishes the corresponding RB; and the determining unit 601 is further configured to determine, according to the location information of the UE, the type of the UE, or the channel information of the UE, the support UE corresponding to the RB of the beneficial UE.

Optionally, the transceiver unit 603 is further configured to receive an RRC message or a MAC CE that carries a cooperative communication request and sent by the beneficial UE; and the determining unit 601 is further configured to determine, according to the RRC message or the MAC CE that is sent by the beneficial UE and received by the transceiver unit 603, the RB of the beneficial UE performing cooperative communication, and determine the RB of the beneficial UE performing cooperative communication and the corresponding support UE according to the location information of the UE, the type of the UE, or the channel information of the UE. The configuration unit 602 configures the cooperative RB configuration information of the beneficial UE for the beneficial UE according to the RRC message or the MAC CE that is sent by the beneficial UE and received by the transceiver unit 603; the transceiver unit 603 is configured to send the cooperative RB configuration information of the beneficial UE that is configured by the configuration unit 602 to the beneficial UE, so that the beneficial UE establishes the corresponding cooperative RB; the configuration unit 602 is further configured to configure the cooperative RB configuration information of the support UE for the support UE after the determining unit 601 determines the support UE corresponding to the RB of the beneficial UE; and the transceiver unit 603 is configured to send the cooperative RB configuration information of the support UE that is configured by the configuration unit 602 to the support UE, so that the support UE establishes the corresponding cooperative RB; or the configuration unit 602 is further configured to: after the determining unit 601 determines the support UE corresponding to the RB of the beneficial UE performing cooperative communication, configure the cooperative RB configuration information of the beneficial UE and the cooperative RB configuration information of the support UE respectively for the beneficial UE and the support UE that are determined by the determining unit 601; and the transceiver unit 603 is further configured to send the cooperative RB configuration information of the beneficial UE that is configured by the configuration unit 602 to the beneficial UE, and send the cooperative RB configuration information of the support UE that is configured by the configuration unit 602 to the support UE, so that the beneficial UE and the support UE establish the corresponding cooperative RB, respectively.

Optionally, the transceiver unit 603 is further configured to receive a cooperative RB configuration rejection message sent by the support UE, where the cooperative RB configuration rejection message is fed back by the support UE to the base station due to absence of a supporting capability of the support UE, or a user policy or a poor state of a short-distance link.

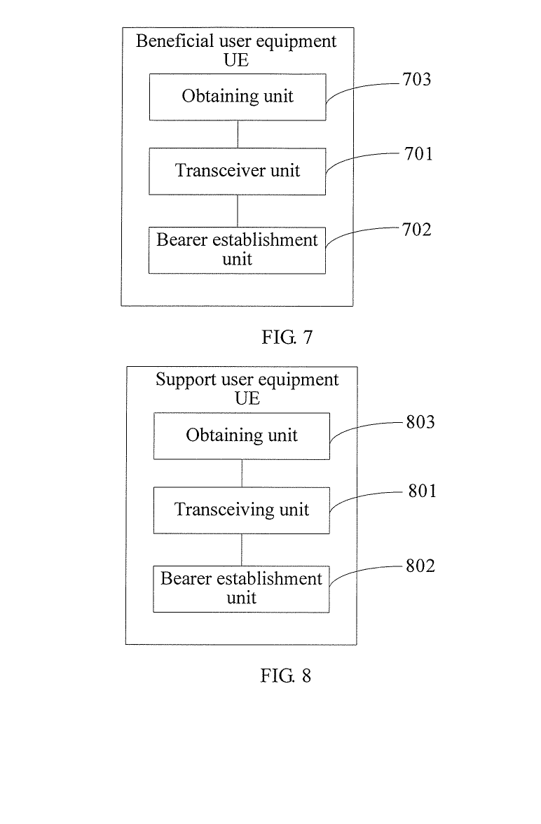

An embodiment of the present invention further provides paired UEs, which include: one beneficial UE and at least one support UE. As shown in FIG. 7, the beneficial UE includes a transceiver unit 701 and a bearer establishment unit 702, and as shown in FIG. 8, the support UE includes a transceiver unit 801 and a bearer establishment unit 802.

The transceiver unit 701 of the beneficial UE is configured to receive cooperative RB configuration information of the beneficial UE that is sent by a base station; and the transceiver unit 801 of the support UE is configured to receive cooperative RB configuration information of the support UE that is sent by the base station, where the cooperative RB configuration information is sent by the base station after the base station determines an RB of the beneficial UE and the support UE in the paired UEs performing cooperative communication.

The bearer establishment unit 702 of the beneficial UE is configured to establish a corresponding cooperative RB according to the cooperative RB configuration information received by the transceiver unit of the beneficial UE; and the bearer establishment unit 802 of the support UE is configured to establish a corresponding cooperative RB according to the cooperative RB configuration information received by the transceiver unit of the support UE.

The transceiver unit 701 of the beneficial UE and the transceiver unit 801 of the support UE perform cooperative communication with the base station.

The beneficial UE further includes an obtaining unit 703, and the support UE further includes an obtaining unit 803.

The obtaining unit 703 of the beneficial UE is configured to obtain a pairing identifier of the beneficial UE; and the obtaining unit 803 of the support UE is configured to obtain a pairing identifier of the support UE.

When the beneficial UE is close to the support UE, the beneficial UE may negotiate with the support UE to obtain the pairing identifier of the beneficial UE performing cooperative communication and the pairing identifier of the support UE, respectively. Alternatively, a user may perform negotiation and configure the pairing identifier of the beneficial UE performing cooperative communication and the pairing identifier of the support UE for the beneficial UE and the support UE. Here, the pairing identifier may include a random number, a subscriber number, a uniform group-RNTI, or the like of any one of the beneficial UE and the support UE.

The transceiver unit 701 of the beneficial UE is further configured to send a radio resource control RRC message carrying the pairing identifier of the beneficial UE that is obtained by the obtaining unit 703 of the beneficial UE and an NAS message packet for requesting establishment of a bearer to the base station, so that the base station returns RB configuration information of the beneficial UE to the beneficial UE according to the received RRC message sent by the beneficial UE; the transceiver unit 701 of the beneficial UE is further configured to receive the RB configuration information of the beneficial UE that is returned by the base station; and the bearer establishment unit 702 of the beneficial UE is further configured to establish a corresponding RB according to the RB configuration information of the beneficial UE that is received by the transceiver unit 701 of the beneficial UE.

The transceiver unit 801 of the support UE is further configured to send an RRC message or a medium access control layer control element MAC CE that carries the pairing identifier of the support UE to the base station, so that the base station reserves an RRC connection of the support UE, stores the pairing identifier of the support UE, and determines the support UE consistent with the pairing identifier of the beneficial UE as a support UE corresponding to the RB of the beneficial UE.

The transceiver unit 701 of the beneficial UE is further configured to receive the RB configuration information of the beneficial UE that is sent by the base station; and the bearer establishment unit 702 of the beneficial UE is further configured to establish the corresponding RB according to the RB configuration information of the beneficial UE that is received by the transceiver unit 701 of the beneficial UE, so that the base station determines, according to location information of the UE, a type of the UE, or channel information of the UE, the support UE corresponding to the RB of the beneficial UE. For example, the base station may determine a UE of which a distance to the beneficial UE is smaller than a preset threshold as the support UE corresponding to the RB of the beneficial UE, or determine a UE with a good channel quality as the support UE corresponding to the RB of the beneficial UE; or a dedicated support UE is set in a cell covered by the base station, and the base station may determine the dedicated support UE as the support UE corresponding to the RB of the beneficial UE.

The RB configuration information of the beneficial UE is sent by the base station after determining, according to received cooperative communication UE information sent by a core network device, the beneficial UE performing cooperative communication, where the cooperative communication UE information includes information of the beneficial UE that needs to perform cooperative communication.

The obtaining unit 703 of the beneficial UE is configured to obtain the pairing identifier of the beneficial UE; and the obtaining unit 803 of the support UE is configured to obtain the pairing identifier of the support UE. The transceiver unit 701 of the beneficial UE is further configured to send an RRC message or a MAC CE that carries the pairing identifier obtained by the obtaining unit of the beneficial UE to the base station; and the transceiver unit 801 of the support UE is further configured to send an RRC message or a MAC CE that carries the pairing identifier obtained by the obtaining unit of the support UE to the base station, so that the base station uses a UE with a pairing identifier that is consistent with the pairing identifier of the beneficial UE as the support UE corresponding to the RB of the beneficial UE. Optionally, the RRC message or the MAC CE that is sent by the transceiver unit 701 of the beneficial UE and the transceiver unit 801 of the support UE respectively to the base station further carries index information of an RB performing cooperative communication, so that the base station determines, according to the index information of the RB, the RB of the beneficial UE performing cooperative communication, and further, the base station uses a UE with a pairing identifier that is consistent with the pairing identifier of the beneficial UE as the support UE corresponding to the RB of the beneficial UE performing cooperative communication.

The pairing identifier includes a random number, a subscriber number of anyone of the beneficial UE and the support UE or a uniform group radio network temporary identifier group-RNTI.

The transceiver unit 801 of the support UE is further configured to send an RRC message or a MAC CE that carries a user identifier of the beneficial UE to the base station, so that the base station reserves an RRC connection of the support UE according to the RRC message or the MAC CE, and determines, according to the user identifier of the beneficial UE, that the support UE is the support UE corresponding to the RB of the beneficial UE, where the user identifier of the beneficial UE includes a cell radio network temporary identifier C-RNTI or a subscriber number of the beneficial UE.

The transceiver unit 701 of the beneficial UE is further configured to send an RRC message or a MAC CE that carries a cooperative communication request to the base station, so that the base station determines, according to the received RRC message or MAC CE that is sent by the beneficial UE, the RB of the beneficial UE performing cooperative communication; and determines the RB of the beneficial UE performing cooperative communication and the corresponding support UE according to the location information of the UE, the type of the UE, or the channel information of the UE.

The transceiver unit 801 of the support UE in the paired UEs is further configured to feed back a cooperative RB configuration rejection message to the base station due to absence of a supporting capability of the support UE, or a user policy or a poor state of a short-distance link.

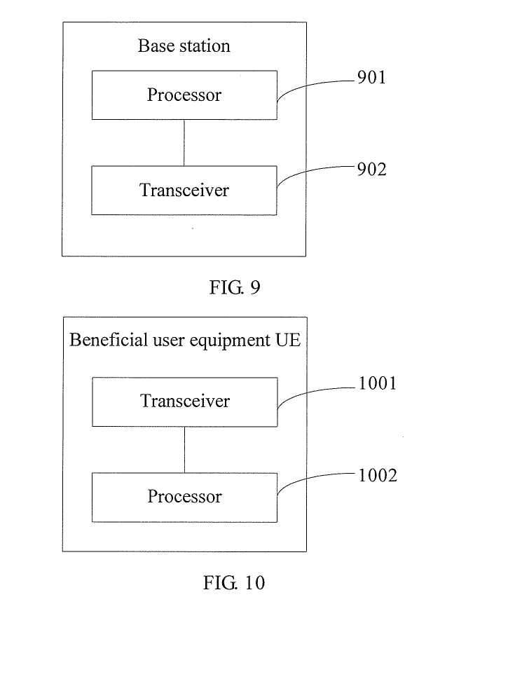

An embodiment of the present invention further provides a base station. As shown in FIG. 9, the base station includes a processor 901 and a transceiver 902.

The processor 901 is configured to determine an RB of a beneficial UE performing cooperative communication and a support UE corresponding to the RB of the beneficial UE.

In a conventional process of normal communication of a network, if a UE needs to perform a service such as data uploading after accessing an access network, the UE sends an NAS message for requesting establishment of a bearer to a core network device through a base station, and after receiving the NAS message, the core network device instructs the base station to establish an RB for the UE, so as to perform a relevant service. When an environment where the UE is located are poor, a signal is not good, and a relevant service cannot be normally performed, the UE may perform multiple users cooperative communication as a beneficial UE, and a support UE with a good signal that is near the beneficial UE forwards relevant service information in the network for the beneficial UE, so as to perform the relevant service.

The processor 901 of the base station may determine the RB of the beneficial UE performing cooperative communication and the corresponding support UE according to a message that carries a pairing identifier and is sent by the beneficial UE and the support UE, or the processor 901 of the base station determines the RB of the beneficial UE performing cooperative communication and the corresponding support UE according to a message that carries a user identifier of the beneficial UE and is sent by the support UE, or the processor 901 of the base station determines the RB of the beneficial UE performing cooperative communication and the corresponding support UE according to location information of the UE, a type of the UE, or channel information of the UE. For example, the processor 901 of the base station may determine a UE of which a distance to the beneficial UE is smaller than a preset threshold as the support UE corresponding to the RB of the beneficial UE, or determine a UE with a good channel quality as the support UE corresponding to the RB of the beneficial UE; or a dedicated support UE is set in a cell covered by the base station, and the processor 901 of the base station may determine the dedicated support UE as the support UE corresponding to the RB of the beneficial UE.

The processor 901 is configured to configure cooperative RB configuration information of the beneficial UE and cooperative RB configuration information of the support UE respectively for the beneficial UE and the support UE.

The transceiver 902 is configured to send the cooperative RB configuration information of the beneficial UE that is configured by the processor 901 to the beneficial UE, and send the cooperative RB configuration information of the support UE that is configured by the processor 901 to the support UE, so that the beneficial UE and the support UE establish a corresponding cooperative RB, respectively.

The transceiver 902 is further configured to transmit service data of the beneficial UE with the beneficial UE and the support UE to perform cooperative communication.

In a situation in which the base station determines the RB of the beneficial UE performing cooperative communication and the corresponding support UE according to the message that carries the pairing identifier and is sent by the beneficial UE and the support UE:

When the beneficial UE and the support UE do not establish a conventional RB with the base station and are not in an RRC connection state, the transceiver 902 is further configured to receive an RRC message that carries a pairing identifier of the beneficial UE and an NAS message packet for requesting establishment of a bearer and is sent by the beneficial UE; the processor 901 is further configured to send RB configuration information of the beneficial UE to the beneficial UE according to the RRC message sent by the beneficial UE and received by the transceiver 902; the transceiver 902 is further configured to send the RB configuration information of the beneficial UE that is configured by the processor 901 to the beneficial UE, so that the beneficial UE establishes the corresponding cooperative RB; the transceiver 902 is further configured to receive a radio resource control RRC message or a medium access control layer control element MAC CE that carries a pairing identifier of at least one UE and is sent by the at least one UE; a processing unit is configured to reserve an RRC connection of the at least one UE and store the pairing identifier of the at least one UE according to the RRC message or the MAC CE that is sent by the at least one UE and received by the transceiver 902; and the processor 901 is configured to determine a UE corresponding to a pairing identifier, which is consistent with the pairing identifier of the beneficial UE in the pairing identifier of the at least one UE that is received by the transceiver unit, as the support UE corresponding to the RB of the beneficial UE.

When the beneficial UE and the support UE have established a conventional RB with the base station and are in RRC connection state, the transceiver 902 is configured to receive RRC messages or MAC CEs that carry pairing identifiers and that are sent by the beneficial UE and other UEs; and the processor 901 is configured to determine, according to the pairing identifier received by the transceiver 902, a UE with a pairing identifier that is consistent with the pairing identifier of the beneficial UE in the other UEs as the support UE corresponding to the RB of the beneficial UE. Optionally, the RRC message or the MAC CE that is sent by the beneficial UE and received by the transceiver 902 further carries index information of an RB performing cooperative communication; and the processor 901 is further configured to determine, according to the index information of the RB, the RB of the beneficial UE performing cooperative communication, and use a UE with a pairing identifier that is consistent with the pairing identifier of the beneficial UE as the support UE corresponding to the RB of the beneficial UE performing cooperative communication.

When the RB configuration information of the beneficial UE that is configured by the base station for the beneficial UE according to the RRC message or the MAC CE that is received by the transceiver 902 is the cooperative RB configuration information, the processor 901 is configured to configure the cooperative RB configuration information of the beneficial UE for the beneficial UE according to the RRC message or the MAC CE that is received by the transceiver 902; the transceiver 902 is configured to send the cooperative RB configuration information of the beneficial UE that is configured by the processor 901 to the beneficial UE, so that the beneficial UE establishes the corresponding cooperative RB; the processor 901 is further configured to configure the cooperative RB configuration information of the support UE of the support UE after the processor 901 determines the support UE corresponding to the RB of the beneficial UE; and the transceiver 902 is configured to send the cooperative RB configuration information of the support UE that is configured by the processor 901 to the support UE, so that the support UE establishes the corresponding cooperative RB.

When the RB configuration information of the beneficial UE that is configured by the base station for the beneficial UE according to the RRC message or the MAC CE that is received by the transceiver 902 is conventional RB configuration information, the processor 901 is further configured to: after the processor 901 determines the support UE corresponding to the RB of the beneficial UE performing cooperative communication, configure the cooperative RB configuration information of the beneficial UE and the cooperative RB configuration information of the support UE respectively for the beneficial UE and the support UE that are determined by the processor 901; and the transceiver 902 is further configured to send the cooperative RB configuration information of the beneficial UE that is configured by the processor 901 to the beneficial UE and send the cooperative RB configuration information of the support UE that is configured by the processor 901 to the support UE, so that the beneficial UE and the support UE establish the corresponding cooperative RB, respectively.

The pairing identifier includes a random number, a subscriber number of any one of the beneficial UE and the support UE or a uniform group radio network temporary identifier group-RNTI.

In a situation in which the base station determines the RB of the beneficial UE performing cooperative communication and the corresponding support UE according to the message that carries the user identifier of the beneficial UE and is sent by the support UE:

The transceiver 902 is further configured to receive an RRC message or a MAC CE that carries the user identifier of the beneficial UE and is sent by the support UE; and the processor 901 is configured to reserve an RRC connection of the support UE according to the RRC message or the MAC CE that is received by the transceiver 902, and determine, according to the user identifier of the beneficial UE, that the support UE is the support UE corresponding to the RB of the beneficial UE, where the user identifier of the beneficial UE includes a cell radio network temporary identifier C-RNTI or a subscriber number of the beneficial UE.

In a situation in which the base station determines the RB of the beneficial UE performing cooperative communication and the corresponding support UE according to the location information of the UE, the type of the UE, or the channel information of the UE:

The processor 901 is further configured to determine the RB of the beneficial UE performing cooperative communication and the corresponding support UE according to the location information of the UE, the type of the UE, or the channel information of the UE.

Optionally, the transceiver 902 is further configured to receive cooperative communication UE information sent by a core network device, where the cooperative communication UE information includes information of the beneficial UE that needs to perform cooperative communication; the processor 901 is further configured to determine, according to the cooperative communication UE information, the beneficial UE performing cooperative communication; the processor 901 is further configured to configure the RB configuration information of the beneficial UE for the beneficial UE determined by the processor 901; the transceiver 902 is further configured to send the RB configuration information of the beneficial UE that is configured by the processor 901 to the beneficial UE, so that the beneficial UE establishes the corresponding RB; and the processor 901 is further configured to determine, according to the location information of the UE, the type of the UE, or the channel information of the UE, the support UE corresponding to the RB of the beneficial UE.

Optionally, the transceiver 902 is further configured to receive an RRC message or a MAC CE that carries a cooperative communication request and sent by the beneficial UE; and the processor 901 is further configured to determine, according to the RRC message or the MAC CE that is sent by the beneficial UE and received by the transceiver 902, the RB of the beneficial UE performing cooperative communication, and determine the RB of the beneficial UE performing cooperative communication and the corresponding support UE according to the location information of the UE, the type of the UE, or the channel information of the UE. The processor 901 configures the cooperative RB configuration information of the beneficial UE for the beneficial UE according to the RRC message or the MAC CE that is sent by the beneficial UE and received by the transceiver 902; the transceiver 902 is configured to send the cooperative RB configuration information of the beneficial UE that is configured by the processor 901 to the beneficial UE, so that the beneficial UE establishes the corresponding cooperative RB; the processor 901 is further configured to configure the cooperative RB configuration information of the support UE for the support UE after the processor 901 determines the support UE corresponding to the RB of the beneficial UE; and the transceiver 902 is further configured to send the cooperative RB configuration information of the support UE that is configured by the processor 901 to the support UE, so that the support UE establishes the corresponding cooperative RB; or the processor 901 is further configured to: after the processor 901 determines the support UE corresponding to the RB of the beneficial UE performing cooperative communication, configure the cooperative RB configuration information of the beneficial UE and the cooperative RB configuration information of the support UE respectively for the beneficial UE and the support UE that are determined by the processor 901; and the transceiver 902 is further configured to send the cooperative RB configuration information of the beneficial UE that is configured by the processor 901 to the beneficial UE, and send the cooperative RB configuration information of the support UE that is configured by the processor 901 to the support UE, so that the beneficial UE and the support UE establish the corresponding cooperative RB, respectively.

Optionally, the transceiver 902 is further configured to receive a cooperative RB configuration rejection message sent by the support UE, where the cooperative RB configuration rejection message is fed back by the support UE to the base station due to absence of a supporting capability of the support UE, or a user policy or a poor state of a short-distance link.

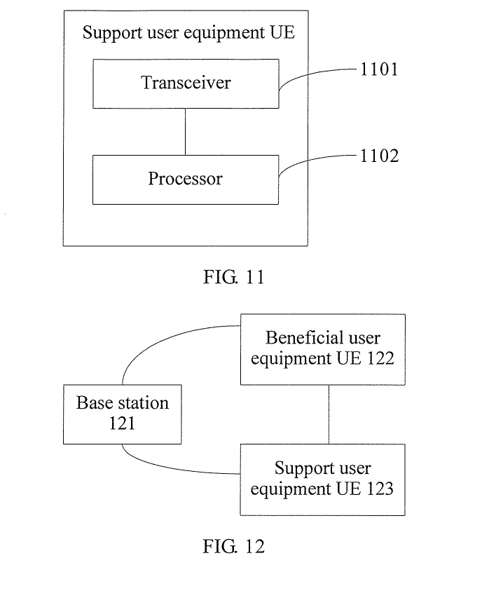

An embodiment of the present invention further provides paired UEs, which include: one beneficial UE and at least one support UE. As shown in FIG. 10, the beneficial UE includes a transceiver 1001 and a processor 1002, and as shown in FIG. 11, the support UE includes a transceiver 1101 and a processor 1102.

The transceiver 1001 of the beneficial UE is configured to receive cooperative RB configuration information of the beneficial UE that is sent by a base station; and the transceiver 1101 of the support UE is configured to receive cooperative RB configuration information of the support UE that is sent by the base station, where the cooperative RB configuration information is sent by the base station after the base station determines an RB of the beneficial UE and the support UE in the paired UEs performing cooperative communication.

The processor 1002 of the beneficial UE is configured to establish a corresponding cooperative RB according to the cooperative RB configuration information received by the transceiver of the beneficial UE; and the processor 1102 of the support UE is configured to establish a corresponding cooperative RB according to the cooperative RB configuration information received by the transceiver of the support UE.

The transceiver 1001 of the beneficial UE and the transceiver 1101 of the support UE perform cooperative communication with the base station.

The beneficial UE further includes a processor 1002, and the support UE further includes an obtaining unit 8023.

The processor 1002 of the beneficial UE is configured to obtain a pairing identifier of the beneficial UE; and the processor 1102 of the support UE is configured to obtain a pairing identifier of the support UE.

When the beneficial UE is close to the support UE, the beneficial UE may negotiate with the support UE to obtain the pairing identifier of the beneficial UE performing cooperative communication and the pairing identifier of the support UE, respectively. Alternatively, a user may perform negotiation and configure the pairing identifier of the beneficial UE performing cooperative communication and the pairing identifier of the support UE for the beneficial UE and the support UE. Here, the pairing identifier may include a random number, a subscriber number, a uniform group-RNTI, or the like of any one of the beneficial UE and the support UE.

The transceiver 1001 of the beneficial UE is further configured to send a radio resource control RRC message carrying the pairing identifier of the beneficial UE that is obtained by the processor 1002 of the beneficial UE and an NAS message packet for requesting establishment of a bearer to the base station, so that the base station returns RB configuration information of the beneficial UE to the beneficial UE according to the received RRC message sent by the beneficial UE; the transceiver 1001 of the beneficial UE is further configured to receive the RB configuration information of the beneficial UE that is returned by the base station; and the processor 1002 of the beneficial UE is further configured to establish a corresponding RB according to the RB configuration information of the beneficial UE that is received by the transceiver 1001 of the beneficial UE.

The transceiver 1101 of the support UE is further configured to send an RRC message or a medium access control layer control element MAC CE that carries the pairing identifier of the support UE to the base station, so that the base station reserves an RRC connection of the support UE, stores the pairing identifier of the support UE, and determines the support UE consistent with the pairing identifier of the beneficial UE as a support UE corresponding to the RB of the beneficial UE.

The transceiver 1001 of the beneficial UE is further configured to receive the RB configuration information of the beneficial UE that is sent by the base station; and the processor 1002 of the beneficial UE is further configured to establish the corresponding RB according to the RB configuration information of the beneficial UE that is received by the transceiver 1001 of the beneficial UE, so that the base station determines, according to location information of the UE, a type of the UE, or channel information of the UE, the support UE corresponding to the RB of the beneficial UE, where the RB configuration information of the beneficial UE is sent by the base station after determining, according to received cooperative communication UE information sent by a core network device, the beneficial UE performing cooperative communication, and the cooperative communication UE information includes information of the beneficial UE that needs to perform cooperative communication.

The processor 1002 of the beneficial UE is configured to obtain the pairing identifier of the beneficial UE; and the processor 1102 of the support UE is configured to obtain the pairing identifier of the support UE. The transceiver 1001 of the beneficial UE is further configured to send an RRC message or a MAC CE that carries the pairing identifier obtained by the obtaining unit of the beneficial UE to the base station; and the transceiver 1101 of the support UE is further configured to send an RRC message or a MAC CE that carries the pairing identifier obtained by the obtaining unit of the support UE to the base station, so that the base station uses a UE with a pairing identifier that is consistent with the pairing identifier of the beneficial UE as the support UE corresponding to the RB of the beneficial UE. Optionally, the RRC message or the MAC CE that is sent by the transceiver 1001 of the beneficial UE and the transceiver 1101 of the support UE respectively to the base station further carries index information of an RB performing cooperative communication, so that the base station determines, according to the index information of the RB, the RB of the beneficial UE performing cooperative communication, and further, the base station uses a UE with a pairing identifier that is consistent with the pairing identifier of the beneficial UE as the support UE corresponding to the RB of the beneficial UE performing cooperative communication.

The pairing identifier includes a random number, a subscriber number of any one of the beneficial UE and the support UE or a uniform group radio network temporary identifier group-RNTI.

The transceiver 1101 of the support UE is further configured to send an RRC message or a MAC CE that carries a user identifier of the beneficial UE to the base station, so that the base station reserves an RRC connection of the support UE according to the RRC message or the MAC CE, and determines, according to the user identifier of the beneficial UE, that the support UE is the support UE corresponding to the RB of the beneficial UE, where the user identifier of the beneficial UE includes a cell radio network temporary identifier C-RNTI or a subscriber number of the beneficial UE.

The transceiver 1001 of the beneficial UE is further configured to send an RRC message or a MAC CE that carries a cooperative communication request to the base station, so that the base station determines, according to the received RRC message or MAC CE that is sent by the beneficial UE, the RB of the beneficial UE performing cooperative communication, and determines the RB of the beneficial UE performing cooperative communication and the corresponding support UE according to the location information of the UE, the type of the UE, or the channel information of the UE.

The transceiver 1101 of the support UE in the paired UEs is further configured to feed back a cooperative RB configuration rejection message to the base station due to absence of a supporting capability of the support UE, or a user policy or a poor state of a short-distance link.

An embodiment of the present invention further provides a system for establishing an RB. As shown in FIG. 12, the system includes: a base station 121 and paired UEs, where the paired UEs include one beneficial UE 122 and at least one support UE 123.

The base station 121 determines an RB of the beneficial UE 122 performing cooperative communication and the corresponding support UE 123, configures corresponding cooperative RB configuration information for the beneficial UE 122 and the corresponding support UE 123, and then, sends the corresponding cooperative RB configuration information to the beneficial UE 122 and the corresponding support UE 123, respectively. The UE may be a support UE or a beneficial UE, and receive the corresponding cooperative RB configuration information sent by the base station 121, and establish a corresponding cooperative RB; in this way, the beneficial UE 122 and the support UE 123 form a cooperative communication group, and cooperative communication may be performed.

The base station 121 may determine the RB of the beneficial UE performing cooperative communication and the corresponding support UE according to location information of the UE, a type of the UE, or channel information of the UE, or determine the RB of the beneficial UE 122 performing cooperative communication and the corresponding support UE 123 according to a message that carries a pairing identifier and is sent by the UE, where the pairing identifier is obtained through negotiation by the beneficial UE 122 with the support UE 123.

The embodiments of the present invention provide a method, an apparatus, and a system for establishing a radio bearer. A base station determines an RB of a beneficial UE performing cooperative communication and a corresponding support UE, and sends configured corresponding cooperative RB configuration information to the beneficial UE and the corresponding support UE, so that the beneficial UE and the corresponding support UE establish a corresponding cooperative RB; therefore, a cooperative communication group is formed, and cooperative communication is performed.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for establishing a radio bearer (RB), the method comprising:
determining, by a base station, an RB of a beneficial user equipment (UE) performing cooperative communication and a support UE corresponding to the RB of the beneficial UE;
sending, by the base station, cooperative RB configuration information of the beneficial UE to the beneficial UE, and sending cooperative RB configuration information of the support UE to the support UE; and
performing, by the base station, cooperative communication with the beneficial UE and the support UE.

2. The method according to claim 1, wherein determining, by a base station, an RB of a beneficial UE performing cooperative communication and a support UE corresponding to the RB of the beneficial UE comprises:
receiving, by the base station, a radio resource control (RRC) message which carries a pairing identifier of the beneficial UE and a non-access stratum (NAS) message packet for requesting establishment of a bearer and is sent by the beneficial UE;
returning, by the base station, RB configuration information of the beneficial UE to the beneficial UE according to the received RRC message sent by the beneficial UE for establishing a corresponding RB;
after receiving an RRC message or a medium access control layer control element (MAC CE) that carries a pairing identifier of at least one UE and is sent by the at least one UE, reserving, by the base station, an RRC connection of the at least one UE, and storing the pairing identifier of the at least one UE; and
determining, by the base station, a UE with a pairing identifier that is consistent with the pairing identifier of the beneficial UE as the support UE corresponding to the RB of the beneficial UE.

3. The method according to claim 2, wherein sending, by the base station, cooperative RB configuration information of the beneficial UE to the beneficial UE, and sending cooperative RB configuration information of the support UE to the support UE comprises:
after determining the support UE corresponding to the RB of the beneficial UE performing cooperative communication, sending, by the base station, the cooperative RB configuration information of the beneficial UE to the beneficial UE, and sending the cooperative RB configuration information of the support UE to the support UE, respectively; or
when the RB configuration information of the beneficial UE that is sent by the base station to the beneficial UE is the cooperative RB configuration information, and the beneficial UE establishes the corresponding cooperative RB, after determining the support UE corresponding to the RB of the beneficial UE performing cooperative communication, sending, by the base station, the cooperative RB configuration information of the support UE to the corresponding support UE.

4. The method according to claim 1, wherein:
determining, by a base station, an RB of a beneficial UE performing cooperative communication and a support UE corresponding to the beneficial UE comprises:
receiving, by the base station, RRC messages or MAC CEs that carry pairing identifiers and are sent by the beneficial UE and other UEs, and using a UE with a pairing identifier that is consistent with a pairing identifier of the beneficial UE in the other UEs as the support UE corresponding to the RB of the beneficial UE; and
sending, by the base station, cooperative RB configuration information of the beneficial UE to the beneficial UE, and sending cooperative RB configuration information of the support UE to the support UE comprises:
sending, by the base station, the cooperative RB configuration information of the beneficial UE to the beneficial UE according to the received RRC message or MAC CE, and after knowing that the beneficial UE establishes the corresponding cooperative RB, determining the support UE corresponding to the RB of the beneficial UE; and sending, by the base station, the cooperative RB configuration information of the support UE to the corresponding support UE, or
sending, by the base station, the cooperative RB configuration information of the beneficial UE to the beneficial UE, and sending the cooperative RB configuration information of the support UE to the support UE, respectively.

5. The method according to claim 1, wherein determining, by a base station, an RB of a beneficial UE performing cooperative communication and a support UE corresponding to the RB of the beneficial UE comprises:
receiving, by the base station, an RRC message or a MAC CE that carries a user identifier of the beneficial UE and is sent by the support UE; and
reserving, by the base station, an RRC connection of the support UE according to the RRC message or the MAC CE, and determining, according to the user identifier of the beneficial UE, that the support UE is the support UE corresponding to the RB of the beneficial UE, wherein the user identifier of the beneficial UE comprises a cell radio network temporary identifier C-RNTI or a subscriber number of the beneficial UE.

6. The method according to claim 1, wherein determining, by a base station, an RB of a beneficial UE performing cooperative communication and a support UE corresponding to the RB of the beneficial UE comprises:
determining, by the base station, the RB of the beneficial UE and the corresponding support UE according to location information of the UE, a type of the UE, or channel information of the UE.

7. A base station, comprising:
a processor, configured to determine a radio bearer (RB) of a beneficial user equipment (UE) performing cooperative communication and a support UE corresponding to the RB of the beneficial UE, configure cooperative RB configuration information of the beneficial UE and cooperative RB configuration information of the support UE respectively for the beneficial UE and the support UE; and
a transceiver, configured to:
send the cooperative RB configuration information of the beneficial UE that is configured by the processor to the beneficial UE,
send the cooperative RB configuration information of the support UE that is configured by the processor to the support UE, and
perform cooperative communication with the beneficial UE and the support UE under the control of the processor.

8. The base station according to claim 7, wherein:
the transceiver is further configured to receive, from the beneficial UE, a radio resource control (RRC) message that carries a pairing identifier of the beneficial UE and a non-access stratum (NAS) message packet for requesting establishment of a bearer;
the processor is further configured to control the transceiver to send RB configuration information of the beneficial UE to the beneficial UE according to the RRC message sent by the beneficial UE and received by the transceiver;
the transceiver is further configured to receive a RRC message or a medium access control layer control element (MAC CE) that carries a pairing identifier of at least one UE from the at least one UE;
the processor is further configured to reserve an RRC connection of the at least one UE and store the pairing identifier of the at least one UE according to the RRC message or the MAC CE that is sent by the at least one UE and received by the transceiver; and
the processor is configured to determine a UE corresponding to a pairing identifier, which is consistent with the pairing identifier of the beneficial UE in the pairing identifier of the at least one UE that is received by the transceiver, as the support UE corresponding to the RB of the beneficial UE.

9. The base station according to claim 8, wherein:
the transceiver is further configured to receive cooperative communication UE information from a core network device, wherein the cooperative communication UE information comprises information of the beneficial UE that needs to perform cooperative communication;
the processor is further configured to determine, according to the cooperative communication UE information, the beneficial UE, and configure RB configuration information of the beneficial UE for the beneficial UE;
the transceiver is further configured to send the RB configuration information of the beneficial UE that is configured by the processor to the beneficial UE; and
the processor is further configured to determine, according to location information of a UE, a type of a UE, or channel information of a UE, the support UE corresponding to the RB of the beneficial UE.

10. The base station according to claim 8, wherein:
when the RB configuration information of the beneficial UE is conventional RB configuration information of the beneficial UE, the processor is further configured to: after the processor determines the support UE corresponding to the RB of the beneficial UE, configure the cooperative RB configuration information of the beneficial UE and the cooperative RB configuration information of the support UE respectively; and the transceiver is further configured to send the cooperative RB configuration information of the beneficial UE to the beneficial UE, and send the cooperative RB configuration information of the support UE to the support UE; or
when the RB configuration information of the beneficial UE is the cooperative RB configuration information of the beneficial UE, the transceiver is further configured to send the cooperative RB configuration information of the beneficial UE that is configured by the processor to the beneficial UE; the processor is further configured to configure the cooperative RB configuration information of the support UE for the support UE after the processor determines the support UE corresponding to the RB of the beneficial UE; and the transceiver is further configured to send the cooperative RB configuration information of the support UE that is configured by the processor to the corresponding support UE.

11. The base station according to claim 7, wherein:
the transceiver is further configured to receive RRC messages or MAC CEs that carry pairing identifiers and that are sent by the beneficial UE and other UEs;
the processor is configured to determine, according to the pairing identifier received by the transceiver, a UE with a pairing identifier that is consistent with a pairing identifier of the beneficial UE in the other UEs as the support UE corresponding to the RB of the beneficial UE, configure the cooperative RB configuration information of the beneficial UE for the beneficial UE according to the RRC message or the MAC CE that is received by the transceiver, and configure the cooperative RB configuration information of the support UE for the support UE; and
the transceiver is configured to send the cooperative RB configuration information of the beneficial UE that is configured by the processor to the beneficial UE, and send the cooperative RB configuration information of the support UE that is configured by the processor to the support UE.

12. The base station according to claim 11, wherein:
the RRC message or the MAC CE that is sent by the beneficial UE and received by the transceiver further carries index information of an RB performing cooperative communication; and
the processor is further configured to determine, according to the index information of the RB, the RB of the beneficial UE performing cooperative communication.

13. The base station according to any claim 8, wherein the pairing identifier comprises any one of a random number, a subscriber number of any one of the beneficial UE and the support UE or a uniform group radio network temporary identifier (group-RNTI).

14. The base station according to claim 7, wherein:
the transceiver is further configured to receive an RRC message or a MAC CE that carries a user identifier of the beneficial UE and is sent by the support UE; and
the processor is configured to reserve an RRC connection of the support UE according to the RRC message or the MAC CE that is received by the transceiver, and determine, according to the user identifier of the beneficial UE, the support UE corresponding to the RB of the beneficial UE, wherein the user identifier of the beneficial UE comprises any one of a cell radio network temporary identifier (C-RNTI) or a subscriber number of the beneficial UE.

15. The base station according to claim 7, wherein the processor is further configured to determine the RB of the beneficial UE performing cooperative communication and the corresponding support UE according to location information of a UE, a type of a UE, or channel information of a UE.

16. A user equipment (UE), wherein the UE is a beneficial UE and comprises a transceiver coupled with a processor, wherein:
the transceiver is configured to receive cooperative radio bearer (RB) configuration information of the beneficial UE from a base station, wherein the cooperative RB configuration information is sent by the base station after the base station determines an RB of the beneficial UE and a support UE corresponding to the RB of the beneficial UE; and
the processor is configured to establish a cooperative RB according to the cooperative RB configuration information received by the transceiver, and control the transmitter to perform cooperative communication with the base station and the support UE.

17. The UE according to claim 16, wherein:
the processor is further configured to obtain a pairing identifier of the beneficial UE;
the transceiver is further configured to send a radio resource control (RRC) message carrying the pairing identifier of the beneficial UE and a non-access stratum (NAS) message packet for requesting establishment of a bearer to the base station;
the transceiver is configured to receive the RB configuration information of the beneficial UE in response to the RRC message; and
the processor is further configured to establish a RB according to the RB configuration information of the beneficial UE that is received by the transceiver.

18. The UE according to claim 16, wherein:
the processor is further configured to obtain a pairing identifier of the beneficial UE; and
the transceiver is further configured to send an RRC message or a MAC CE that carries the pairing identifier obtained by the processor to the base station, the pairing identifier is for the base station to determine that the UE with the pairing identifier that is consistent with a pairing identifier of the beneficial UE as the support UE corresponding to the RB of the beneficial UE.

19. The UE according to claim 18, wherein the RRC message or the MAC CE that is sent by the transceiver further carries index information of an RB performing cooperative communication, the index information of an RB performing cooperative communication is for the base station to determine, according to the index information of the RB, the RB of the beneficial UE performing cooperative communication.

20. The UE according to claim 17, wherein the pairing identifier comprises any one of a random number, a subscriber number of any one of the beneficial UE and the support UE or a uniform group radio network temporary identifier (group-RNTI).
